(19) United States
(12) Patent Application Publication
(10) Pub. No.: US 2026/0124803 A1
(43) Pub. Date: May 7, 2026

(54) NOZZLE MODULE AND THREE-DIMENSIONAL PRINTER

(71) Applicant: SHENZHEN CREALITY ECOSYSTEM TECHNOLOGY CO., LTD, Shenzhen City (CN)

(72) Inventors: Pengcheng lV, Shenzhen City (CN); Zhangjun SONG, Shenzhen City (CN); Sen HOU, Shenzhen City (CN)

(21) Appl. No.: 19/372,979

(22) Filed: Oct. 29, 2025

(30) Foreign Application Priority Data
Nov. 6, 2024 (CN) 202411582130.0

(51) Int. Cl. B29C 64/209; B29C 48/02; B29C 48/265; B29C 48/86; B29C 48/87; B33Y 30/00

(52) U.S. Cl. CPC B29C 64/209; B29C 48/02; B29C 48/265; B29C 48/865; B29C 48/87; B33Y 30/00

(57) ABSTRACT

A nozzle module and a three-dimensional printer are provided. The nozzle module includes a heat dissipation assembly, a locking assembly, and a nozzle assembly. The rotary member can rotate relative to the clamping ring, and a width of the opening is selectively reduced or increased when the rotary member rotates relative to the clamping ring, thereby enabling the clamping ring to clamp or release the nozzle assembly. Quick assembly and quick disassembly can be achieved, the assembly and the disassembly are convenient, and the assembly efficiency and the disassembly efficiency are improved.

### TECHNICAL FIELD

The present disclosure relates to the field of three-dimensional printing, and in particular to a nozzle module, and a three-dimensional printer.

### BACKGROUND

Fused deposition modeling (FDM) is a method for heating and melting consumables, and then printing and stacking the consumables layer by layer to form a three-dimensional object.

When a nozzle of the three-dimensional printer is blocked, the nozzle needs to be removed from the three-dimensional printer to be cleaned and then remounted. If the nozzle is blocked seriously, it even needs to be replaced, so the convenience of nozzle removal and mounting is particularly important.

In a related technology, the nozzle often do not have a quick disassembly function. Even if some nozzles can be quickly disassembled, the disassembly process is complicated, and other tools are needed to achieve quick disassembly, which seriously affects the efficiency of assembly and disassembly.

### SUMMARY

An embodiment of the present disclosure provides a nozzle module and a three-dimensional printer. Quick assembly and quick disassembly can be achieved, the assembly and the disassembly are convenient, and the assembly and dismounting efficiency is improved.

In a first aspect, a three-dimensional printer provided by the embodiment of the present disclosure includes:
a heat dissipation assembly;
a locking assembly, including a clamping ring fixed to the heat dissipation assembly and a rotary member connected to the clamping ring, where the clamping ring is provided with a clamping hole and an opening that penetrate through the clamping ring in a first direction, and the opening communicates with the clamping hole; and
a nozzle assembly, passing through the clamping hole and the heat dissipation assembly in turn along the first direction.

The rotary member can rotate relative to the clamping ring, a width of the opening is selectively reduced or increased when the rotary member rotates relative to the clamping ring, thereby enabling the clamping ring to clamp or release the nozzle assembly.

In some embodiments, the clamping ring is elastic, when the width of the opening is increased due to the rotation of the rotary member relative to the clamping ring, the nozzle assembly can be disconnected from the clamping ring under the action of its own gravity.

In some embodiments, the clamping ring is provided with two fixed abutting portions which are respectively formed on two sides of the opening in a second direction perpendicular to the first direction, where the second direction is a width direction of the opening.

The rotary member includes a rotatable abutting portion corresponding to the fixed abutting portion, the rotatable abutting portion is provided with a first mating surface, and the fixed abutting portion is provided with a second mating face abutting against the corresponding first mating surface in the second direction.

The rotatable abutting portion can rotate relative to the fixed abutting portion to make the first mating surface press against or release the corresponding second mating surface along the second direction, thereby enabling the clamping ring to clamp or release the nozzle assembly.

In some embodiments, the first mating surface is a cam surface; or the first mating surface and the second mating surface are mutually engaged wedge-shaped surfaces.

In some embodiments, the two fixed abutting portions are a first fixed abutting portion and a second fixed abutting portion.

The rotary member includes a rotatable abutting portion, the rotatable abutting portion is arranged at one side, away from the second fixed abutting portion, of the first fixed abutting portion, and an end surface of one side, away from the second fixed abutting portion, of the first fixed abutting portion is construed as the second mating surface.

In some embodiments, the first mating surface is a cam surface, a central axis of the cam surface is eccentrically arranged relative to a first axis perpendicular to the second direction, and relative positions of the first axis and the second fixed abutting portion are fixed.

The rotary member can rotate around the first axis to enable the first mating surface to press against or release the second mating surface along the second direction.

In some embodiments, the locking assembly further includes a first connector, the first connector includes a first rod portion extending along the second direction, and a first flange portion formed at one end of the first rod portion, the other end of the first rod portion penetrates through the second fixed abutting portion and the first fixed abutting portion in turn and is connected to the rotatable abutting portion.

One end, away from the first fixed abutting portion, of the second fixed abutting portion in the second direction abuts against the first flange portion, and the rotatable abutting portion can rotate around the first axis relative to the first rod portion.

In some embodiments, the rotatable abutting portion is provided with a first assembly hole with the first axis as an axis, and the rotatable butting portion is further provided with an avoidance groove arranged around the first axis and communicating with first assembly hole.

The locking assembly further includes a second connector, and the second connector passes through the first assembly hole.

The first connector passes through the avoidance groove and is fixed to the second connector. In some embodiments, a circumferential direction of the second connector is provided with a second assembly hole extending along a radial direction of the second connector, the first connector is threaded to the second assembly hole, the second connector is further provided with a third assembly hole with the first axis as an axis, and the third assembly hole communicates with the second assembly hole.

The locking assembly further includes a fastener threaded to the third assembly hole, and the fastener is configured to abut against the first connector of the second assembly hole.

In some embodiments, the rotary member includes two rotatable abutting portions spaced apart in the second direction, the two fixed abutting portions are located between the two rotatable abutting portions, at least one of the second rotatable abutting portions is can press against or release the corresponding fixed abutting portion along the second direction, thereby making the two fixed abutting portions close to or far away from each other.

In some embodiments, the first mating surface and the second mating surface are both wedge-shaped surfaces arranged around a second axis parallel to the second direction and extending obliquely in the second direction.

The rotary member can rotate around the second axis to enable the first mating surface to press against or release the second mating surface along the second direction.

In some embodiments, the rotatable abutting portion is provided with a plurality of first mating surfaces arranged around the second axis, and two adjacent first mating surface are connected by a first transition surface.

The fixed abutting portion is provided with a plurality of second mating surfaces arranged around the second axis, and two adjacent second mating surface are connected by a second transition surface.

In some embodiments, the fixed abutting portion is provided with an accommodation hole which is arranged to face the rotatable abutting portion and takes the second axis as an axis, the second mating surface is formed in a bottom surface of the accommodation hole, and the rotatable abutting portion is rotatably connected into the accommodation hole.

In some embodiments, the rotary member further includes two first connecting arms spaced apart and symmetrically arranged in the second direction, and a second connecting arm connected to one end of each of the two connecting arms, and the other ends of the two first connecting arms are fixed with the rotatable abutting portions, respectively.

In some embodiments, the locking assembly further includes two third connectors symmetrically arranged in the second direction.

The third connector includes a second rod portion with the second axis as an axis, and a second flange portion formed at one end of the second rod portion, and the other end of the second rod portion passes through the corresponding rotatable abutting portion and is fixed to the corresponding fixed abutting portion.

One end, away from the fixed abutting portion, of the rotatable abutting portion in the second direction abuts against the second flange portion.

In some embodiments, the rotatable abutting portion is of a split structure, and includes a first connecting portion and a first mating portion which are detachably fixed, the first connecting portion is fixed to the corresponding first connecting arm, and the first mating surface is formed in the first mating portion; or
the rotatable abutting portion is of an integrated structure.

In some embodiments, the fixed abutting portion is of a split structure, and includes a second connecting portion and a second mating portion which are detachably fixed, the second connecting portion is fixed to one side of the opening, and the second mating surface is formed in the second mating portion; or
the fixed abutting portion is of an integrated structure.

In some embodiments, the clamping ring further includes a ring portion, and two fixing portions symmetrically arranged about the ring portion.

The ring portion is provided with the clamping hole and the opening.

One end of the fixing portion is formed in the ring portion, the other end of the fixing portion extends along a circumferential direction of the ring portion and is spaced from the ring portion by a gap, and an end portion of the other end of the fixing portion and the heat dissipation assembly are detachably fixed.

In some embodiments, the heat dissipation assembly includes a heat dissipation member, two heat insulation members, and two fixing members.

The two heat insulation members are symmetrically arranged on two sides of the heat dissipation member in the second direction perpendicular to the first direction, and the fixing member is fixed to the heat dissipation member after passing through the corresponding fixing portion and heat insulation member in turn.

The nozzle assembly passes through the heat dissipation member.

In some embodiments, the nozzle assembly includes a throat, a heat-conducting pipe and a printhead which are sequentially connected in the first direction, where the throat passes through the heat dissipation assembly. The nozzle assembly further includes a locking pipe fixed to a periphery of the heat-conducting pipe, and the locking pipe passes through the clamping hole. In some embodiments, the nozzle module further includes a heating assembly, where the heating assembly is sleeved outside the heat-conducting pipe.

In some embodiments, the heat-conducting pipe includes a pipe portion and a third flange portion protruding from the pipe portion in a circumferential direction, and the third flange portion is arranged at one end, close to the printhead, of the pipe portion.

The locking pipe is threaded to one end, away from the third flange portion, of the pipe portion. The heating assembly is arranged between the third flange portion and the locking pipe.

In a second aspect, a three-dimensional printer provided by the embodiment of the present disclosure includes the nozzle module provided by any foregoing embodiment.

Compared with the prior art, the embodiment of the present disclosure has beneficial characteristics as follows: a nozzle module and a three-dimensional printer are provided. The nozzle module includes a heat dissipation assembly, a locking assembly, and a nozzle assembly. The locking assembly includes a clamping ring fixed to the heat dissipation assembly, and a rotary member connected to the clamping ring. The clamping ring is provided with a clamping hole and an opening that penetrate through the clamping ring, and the opening communicates with the clamping hole. The nozzle assembly passes through the clamping hole and the heat dissipation assembly along the first direction in turn, where the rotary member can rotate relative to the clamping ring, and a width of the opening is selectively reduced or increased when the rotary member rotates relative to the clamping ring, thereby enabling the clamping ring to clamp or release the nozzle assembly. Through the embodiments of the present disclosure, the width of the opening can be reduced by rotating the rotary member, so that the nozzle assembly can be clamped in the clamping hole of the clamping ring to achieve quick assembly. In addition, the assembly process is simple, no other tools are required, and the assembly efficiency is improved. On the contrary, the width of the opening can be increased by reversely rotating the rotary member, so that the clamping ring can release the nozzle assembly to achieve quick disassembly. In addition, the disassembly process is simple, no other tools are required, and the disassembly efficiency is improved.

### BRIEF DESCRIPTION OF THE DRAWINGS

FIG. 1 is a diagram of a three-dimensional structure of a nozzle module according to an embodiment of the present disclosure;

FIG. 2 is a diagram of a structure of a nozzle module according to Embodiment 1 of the present disclosure;

FIG. 3 is a left view of FIG. 2;

FIG. 4 is a bottom view of FIG. 2;

FIG. 5 is a sectional diagram of A-A in FIG. 4;

FIG. 6 is a sectional diagram of B-B in FIG. 4;

FIG. 7 is a diagram of structure when a locking assembly in a nozzle module according to Embodiment 1 of the present disclosure is in a pull-up state;

FIG. 8 is a diagram of structure when a locking assembly in a nozzle module according to Embodiment 1 of the present disclosure is in a put-down state;

FIG. 9 is an exploded view of a locking assembly in a nozzle module according to Embodiment 1 of the present disclosure;

FIG. 10 is a diagram of a three-dimensional structure of a nozzle module according to according to Embodiment 2 of the present disclosure;

FIG. 11 is a diagram of a nozzle module according to Embodiment 2 of the present disclosure;

FIG. 12 is a sectional diagram of C-C in FIG. 11;

FIG. 13 is a sectional diagram of D-D in FIG. 11;

FIG. 14 is a left view of FIG. 11;

FIG. 15 is a sectional diagram of E-E in FIG. 14;

FIG. 16 is a diagram of a structure when a locking assembly in a nozzle module according to Embodiment 2 of the present disclosure is in a pull-up state;

FIG. 17 is an exploded view of a locking assembly in a nozzle module according to Embodiment 2 of the present disclosure;

FIG. 18 is a partial enlarged view of FIG. 17;

FIG. 19 is a diagram of an engagement state of a first wedge-shaped surface and a second wedge-shaped surface when a nozzle module according to Embodiment 2 of the present disclosure is in a release state;

FIG. 20 is a diagram of a cooperation state of a first wedge-shaped surface and a second wedge-shaped surface when a nozzle module according to Embodiment 2 of the present disclosure is in a pull-up state;

FIG. 21 is a diagram of a structure of a first mating portion in a nozzle module according to according to Embodiment 2 of the present disclosure:

FIG. 22 is a diagram of a first mating portion shown in FIG. 21 from another perspective;

FIG. 23 is a bottom view of FIG. 22;

FIG. 24 is a diagram of a structure of a second mating portion in a nozzle module according to according to Embodiment 2 of the present disclosure:

FIG. 25 is a diagram of a cooperation state of a first wedge-shaped surface and a second wedge-shaped surface when a nozzle module according to Embodiment 2 of the present disclosure is in a pull-up state;

FIG. 26 is a diagram of a cooperation state of a first wedge-shaped surface and a second wedge-shaped surface when a nozzle module according to Embodiment 2 of the present disclosure is in a put-down state;

FIG. 27 is a diagram of a structure of a nozzle assembly in a nozzle module according to an embodiment of the present disclosure.

FIG. 28 is a sectional diagram of F-F in FIG. 27.

In the drawings: 1—heat dissipation assembly (101—heat dissipation member, 102—heat insulation member, 103—fixing member), 2—locking assembly (201—clamping ring (2011—clamping hole, 2012—opening, 2013—fixed abutting portion (2013a—first fixed abutting portion, 2013b—second fixed abutting portion, 20131—body (201311—embedding recess), 20132—second mating surface, 20133—second transition surface, 20134—accommodation hole, 20135—second connecting portion (201351—second limiting recess), 20136—second mating portion (201361—second limiting protrusion)), 2014—ring portion, 2015—fixing portion), 202—rotary member (2021—rotatable abutting portion (20211—first mating surface, 20212—first assembly hole, 20213—avoidance groove, 20214—first transition surface, 20215—first connecting portion (202151—first limiting recess), 20216—first mating portion (202161—first limiting protrusion)), 2022—handle portion, 2023—first connecting arm, 2024—second connecting arm), 203—gasket, 204—first connector (2041—first rod portion, 2042—first flange portion), 205—second connector (2051—second assembly hole, 2052—third assembly hole), 206—fastener, 207—third connector (2071—second rod portion, 2072—second flange portion)), 3—nozzle assembly (301—throat, 302—heat-conducting pipe (3021—pipe portion, 3022—third flange portion (30221—mounting hole)), 303—printhead, 304—locking pipe, 305—heat dissipation pipe), 4—heating assembly (401—heating member, 402—protective case, 403—temperature sensor), 5—pressure collector, 6—stopper, 7—first axis, 8—second axis.

### DETAILED DESCRIPTION OF THE INVENTION

To facilitate the understanding of the present disclosure, the present disclosure will be described more fully below with reference to relevant accompanying drawings. Preferred embodiments of the present disclosure are shown in the accompany drawings. However, the present disclosure can be implemented in many different forms and is not limited to the embodiments described herein. On the contrary, these embodiments are provided to make the disclosure of the present disclosure more thoroughly and comprehensively.

It should be noted that when an element is said to be “fixed” to another element, it may be directly on the other element or there may be an intervening element. It should be noted that when an element is said to be “connected” to another element, it may be directly connected to the other element or there may be an intervening element.

Unless otherwise defined, all technical and scientific terms used herein have the same meaning as commonly understood by those skilled in the art. The terminology used in the specification of the present disclosure is only for the purpose of describing specific embodiments rather than limiting the present disclosure.

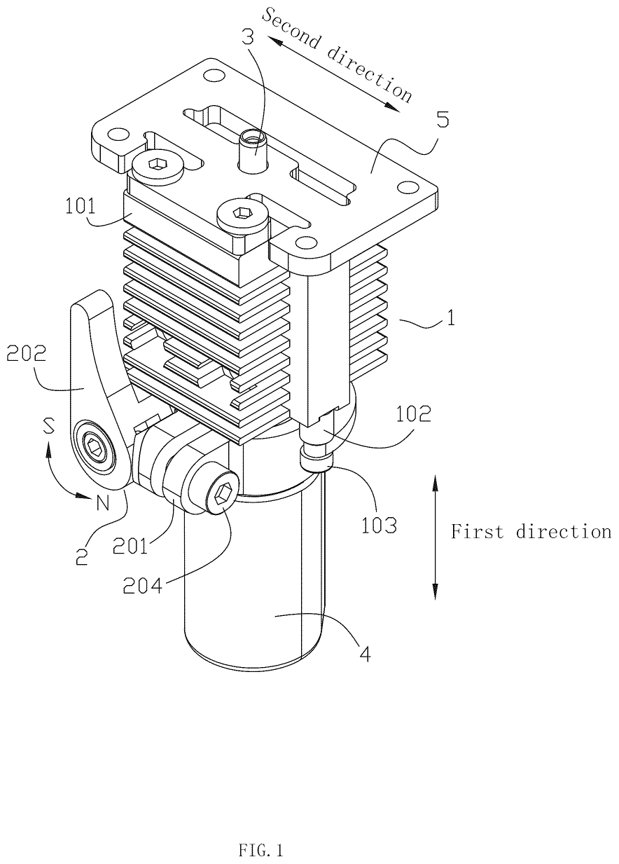

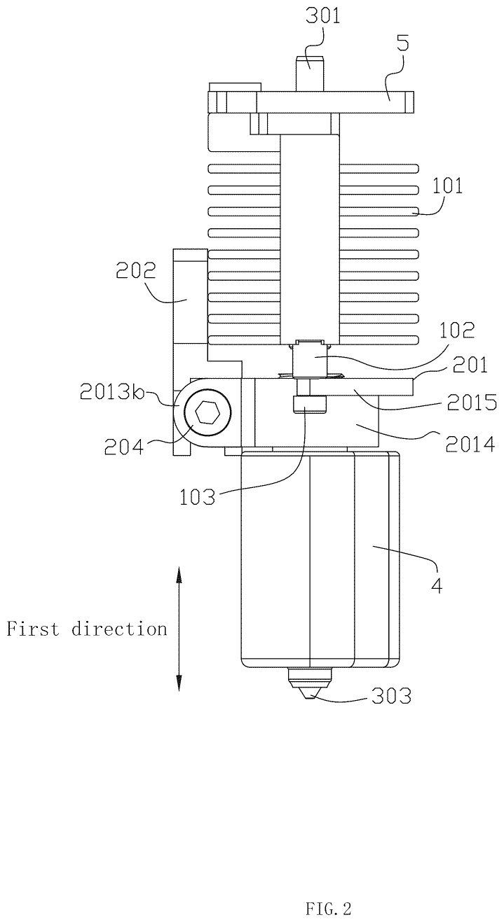

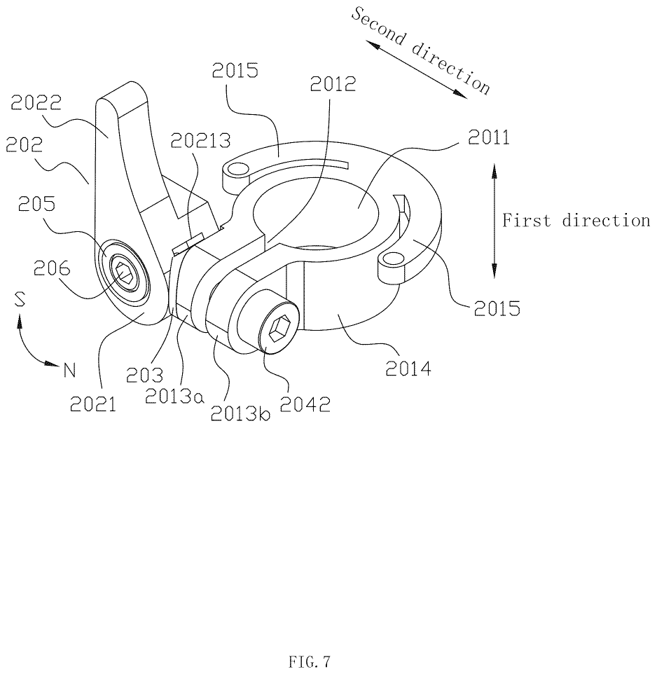

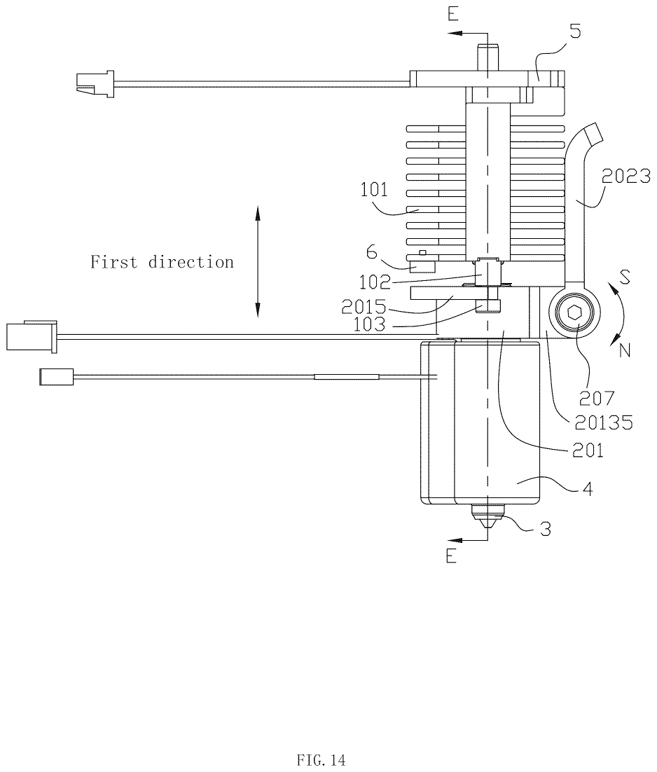

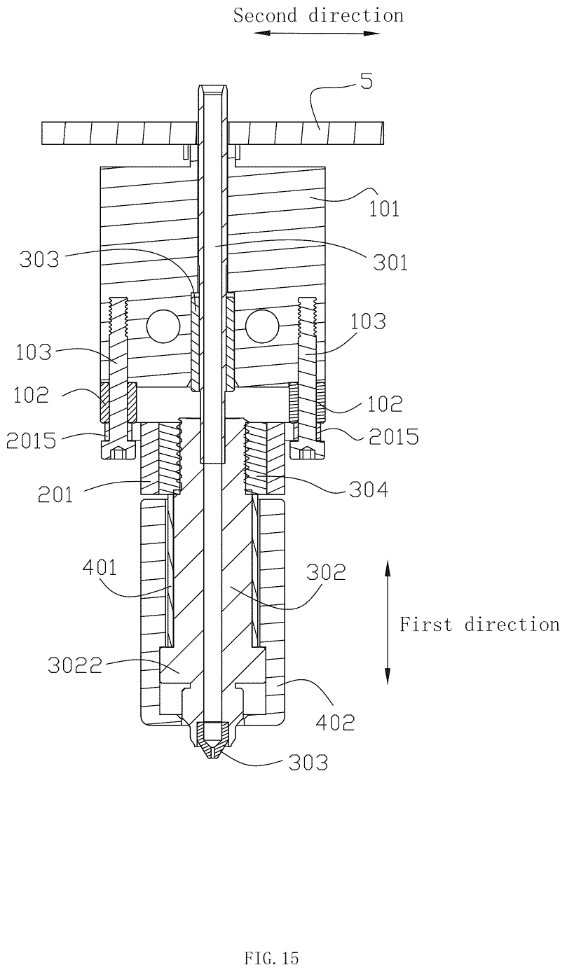

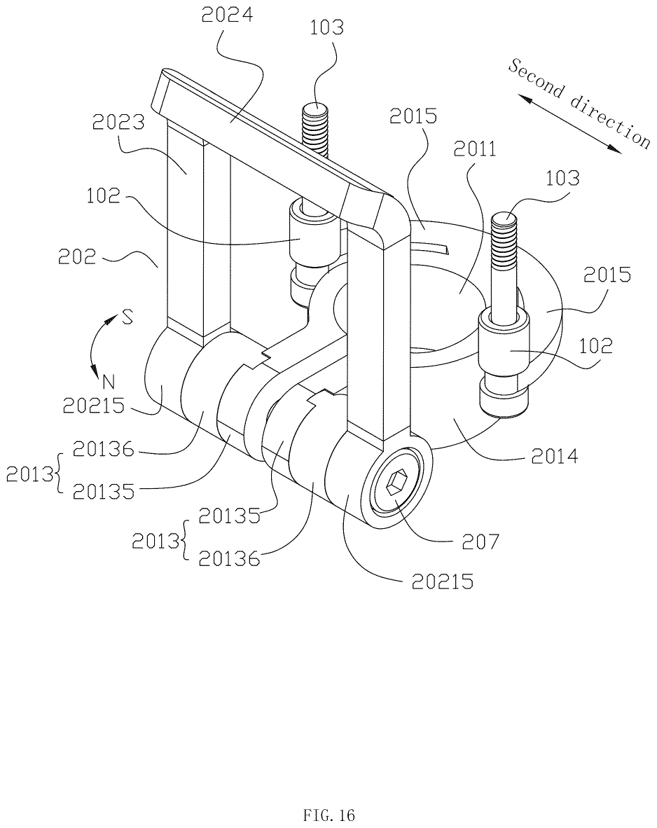

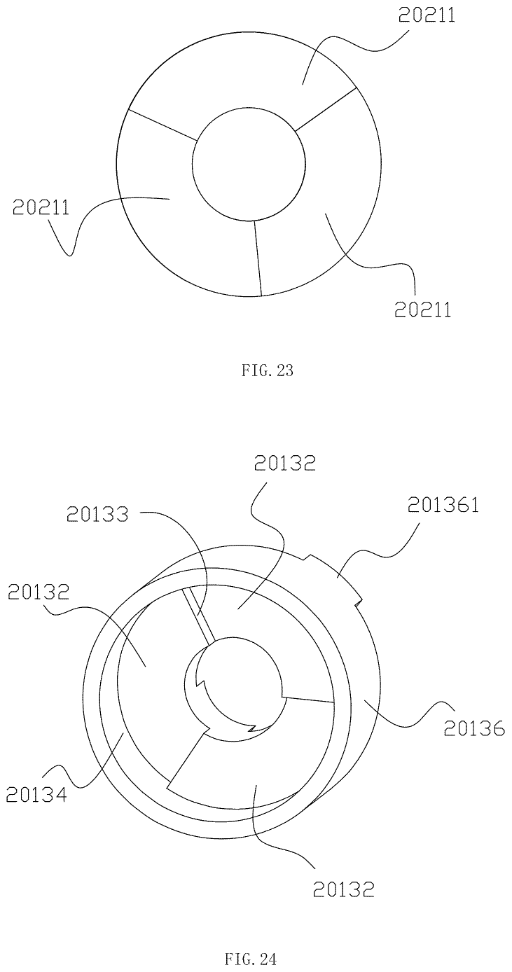

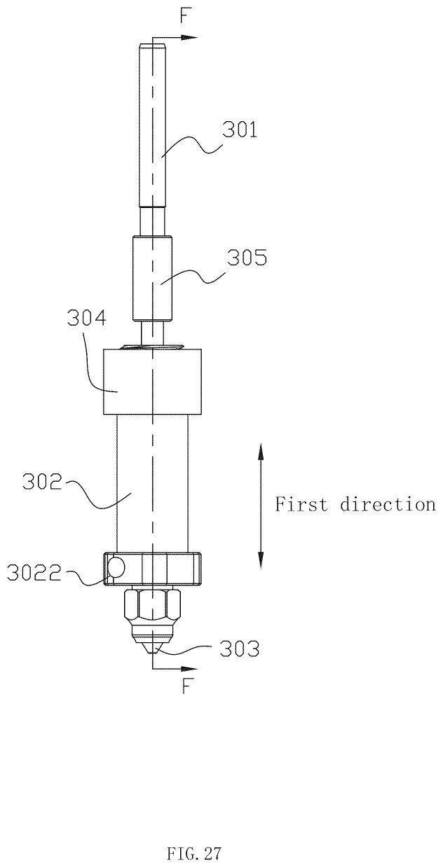

With reference to FIG. 1 to FIG. 28, a nozzle module according to an embodiment of the present disclosure includes a heat dissipation assembly 1, a locking assembly 2, and a nozzle assembly 3. The locking assembly 2 includes a clamping ring 201 and a rotary member 202, where the clamping ring 201 is fixed to the heat dissipation assembly 1, and the rotary member 202 is rotatably connected to the clamping ring 201. The clamping ring 201 is provided with a clamping hole 2011 and an opening 2012, the clamping hole 2011 and the opening 2012 both penetrate through the clamping ring 201 in a first direction, and the opening 2012 communicates with the clamping hole 2011. The nozzle assembly 3 passes through the clamping hole 2011 and the heat dissipation assembly 1 in turn along the first direction. The rotary member 202 can rotate along direction S relative to the clamping ring 201, and the rotary member 202 can also rotate along direction N relative to the clamping ring 201, where the direction N is opposite to the direction S. When the rotary member 202 rotates along the direction S relative to the clamping ring 201, a width of the opening 2012 is gradually reduced to gradually reduce an aperture of the clamping hole 2011, thereby enabling the clamping ring 201 to gradually clamp the nozzle assembly 3. When the rotary member 202 is rotated to a pull-up state along the direction S, the nozzle assembly 3 is clamped into the clamping hole 2011 by the clamping ring 201, where the pull-up state is as shown in FIG. 7 and FIG. 16. When the rotary member 202 rotates along the direction N relative to the clamping ring 201, a width W1 of the opening 2012 is gradually increased to gradually increase the aperture of the clamping hole 2011, thereby enabling the clamping ring 201 to gradually release the nozzle assembly 3. With reference to FIG. 8, when the rotary member 202 is rotated to a put-down state along the direction N, the clamping ring 201 can release the nozzle assembly 3, and a user can take off the nozzle assembly 3 from the nozzle module conveniently.

According to an embodiment of the present disclosure, the width W1 of the opening 2012 can be changed by rotating the rotary member 202, thereby changing the aperture of the clamping hole 2011 and making the clamping ring 202 clamp or release the nozzle assembly 3 passing through the clamping hole 2011. Either quick assembly or quick disassembly can be achieved by rotating once, the assembly and disassembly processes are simple, no other tools are required, and the assembly efficiency and the disassembly efficiency are improved. In addition, the nozzle assembly 3 and the heat dissipation assembly 1 can be firmly fixed by the locking assembly 2, thereby solving a problem that the nozzle assembly 3 rotates and/or moves up and down during the movement, and the nozzle assembly 3 is reliably fixed.

In some embodiments, the clamping ring 201 is elastic. Therefore, when the width W1 of the opening 2012 is increased due to the rotation of the rotary member 202 relative to the clamping ring 201, the nozzle assembly 3 can be disconnected from the clamping ring 201 under the action of its own gravity, thereby effectively avoiding a situation that the clamping ring 201 still clamps the nozzle assembly 3 when the rotary member 202 is rotated to the put-down state. It is further ensured that the nozzle module can achieve quick disassembly, and the disassembly efficiency is improved.

In some embodiments, when the clamping ring 201 clamps the nozzle assembly 3, the opening 2012 still has a certain width. That is, in some embodiments, the width Wi of the opening 2012 can be changed by rotating the rotary member 202 along the direction S, but the opening 2012 cannot be completed closed, so that a certain deformation is reserved, which can effectively avoid a situation that the nozzle assembly 3 cannot be effectively clamped as the opening 2012 has been closed when the rotary member 202 has not been rotated in place. The reliability of the nozzle module is improved, and the clamping ring 201 can clamp the nozzle assembly 3 more effectively.

In some embodiments, the clamping ring 201 is provided with two fixed abutting portions 2013 opposite to each other, the two fixed abutting portions 2013 are respectively arranged on two sides of the opening 2012 in the second direction, where the second direction is perpendicular to the first direction, and the second direction is a width direction of the opening 2012. The rotary member 202 includes a rotatable abutting portion 2021, and the rotatable abutting portion 2021 corresponds to the fixed abutting portion 2013. The rotatable abutting portion 2021 is provided with a first mating surface 20211, the fixed abutting portion 2013 is provided with a second mating surface 20132, and the first mating surface 20211 may abut against the second mating surface 20132 in the second direction. When the rotatable abutting portion 2021 rotates along the direction S relative to the fixed abutting portion 2013, the first mating surface 20211 presses against the second mating surface 20132 along the second direction, making the width W1 of the opening 2012 and the aperture of the clamping hole 2011 reduced. When the rotatable abutting portion 2021 rotates along the direction N relative to the fixed abutting portion 2013, the first mating surface 20211 releases the second mating surface 20132 along the second direction. Releasing the second mating surface 20132 along the second direction refers to reducing or releasing a constraint of the first mating surface 20211 on the second mating surface 20132 in the second direction, so that the second mating surface 20132 can gradually return to a position where the second mating surface 20132 is located in the put-down state. Therefore, releasing the second mating surface 20132 along the second direction by the first mating surface 20211 may increase the width W1 of the opening 2012 and the aperture of the clamping hole 2011, so that the nozzle assembly 3 can be disconnected from the clamping ring 201 under its own gravity, and the user can take off the nozzle assembly 3 from the nozzle module conveniently.

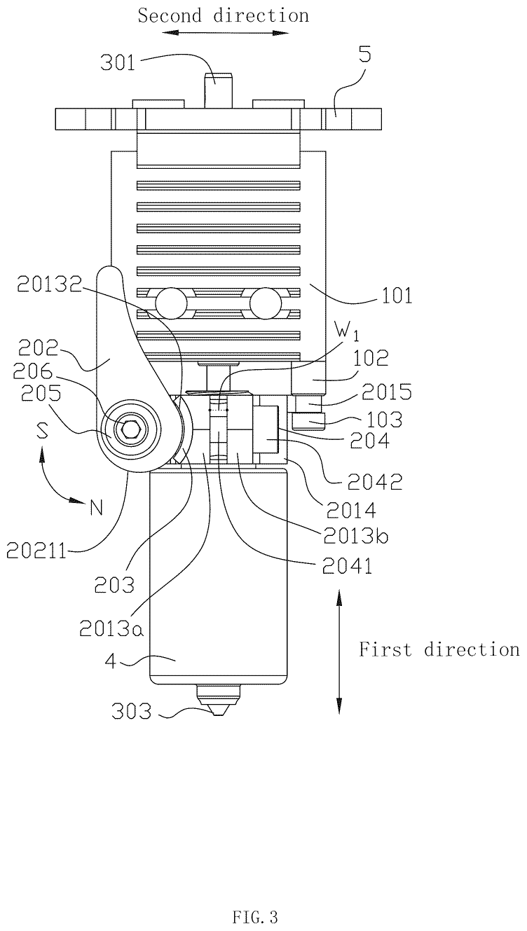

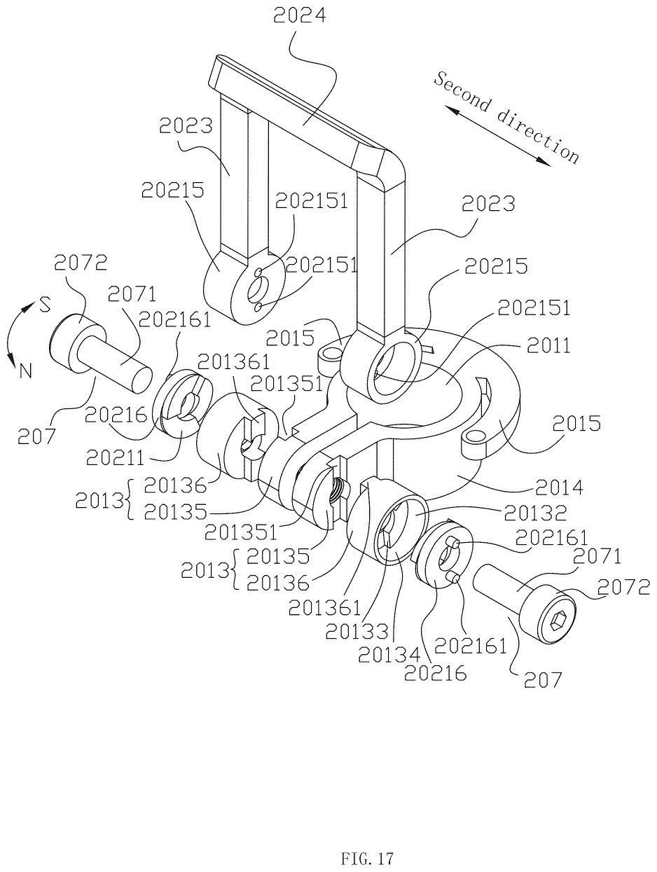

As an example, the first mating surface 20211 may be a cam surface, please referring to FIG. 3, FIG. 7 to FIG. 9. Alternatively, the first mating surface 20211 and the second mating surface 20132 may be mutually engaged wedge-shaped surfaces, please referring to FIG. 17 to FIG. 26. Alternatively, the first mating surface 20211 and the second mating surface 20132 may be other shapes, which can be set according to actual situations.

In some embodiments, with reference to embodiments shown in FIG. 1 to FIG. 9, the rotary member 202 includes one rotatable abutting portion 2021, and two fixed abutting portions 2013 may be a first fixed abutting portion 2013a and a second fixed abutting portion 2013b. The rotatable abutting portion 2021 is arranged at one side, away from the second fixed abutting portion 2013b, of the first fixed abutting portion 2013a, and an end surface of one side, away from the second fixed abutting portion 2013b, of the first fixed abutting portion 2013a is construed as the second mating surface 20132.

In this embodiment, in the process that the rotary member 202 is rotated to the pull-up state shown in FIG. 7 along the direction S, the first mating surface 20211 of the fixed abutting portion 2013 may press against the second mating surface 20132 of the fixed abutting portion 2013a along the second direction, the first fixed abutting portion 2013a is enabled to move toward the second fixed abutting portion 2013b along the second direction to reduce the width W1 of the opening 2012 in the second direction, thereby enabling the clamping ring 201 to apply a pressure to the nozzle assembly 3 to clamp the nozzle assembly 3. In the process that the rotary member 202 is rotated to the put-down state shown in FIG. 8 along the direction N, the rotary member 202 can release the first fixed abutting portion 2013a in the second direction, the first fixed abutting portion 2013a is enabled to move away from the second fixed abutting portion 2013b along the second direction to increase the width W1 of the opening 2012 in the second direction, thereby enabling the clamping ring 201 to release the nozzle assembly 3, and facilitating the user the take off the nozzle assembly 3 from the nozzle module.

As an example, with reference to FIG. 7 to FIG. 9, the first mating surface 20211 may be a cam surface, and a central axis of the cam surface is eccentrically arranged relative to the first axis 7. The first axis 7 is perpendicular to the second direction, and relative positions of the first axis 7 and the second fixed abutting portion 2013b are fixed. That is, the second fixed abutting portion 2013b remains unmoved, and the first fixed abutting portion 2013b can move along the second direction. When the rotary member 202 is rotated around the first axis 7 along the direction S, the first mating surface 20211 presses against the second mating surface 20132 along the second direction, so that the first fixed abutting portion 2013a can move toward the second fixed abutting portion 2013b in the second direction. When the rotary member 202 is rotated around the first axis along the direction N, the first mating surface 20211 releases the second mating surface 20132 along the second direction, so that the first fixed abutting portion 2013a can move away from the second fixed abutting portion 2013b in the second direction.

A working principle of this embodiment is as follows: when the rotary member 202 is rotated to the pull-up state shown in FIG. 7 along the direction S, a distance between the first axis 7 and the second fixed abutting portion 2013b is the maximum or close to the maximum. As the relative positions of the first axis 7 and the second fixed abutting portion 2013b are fixed, that is, the distance between the first axis 7 and the first fixed abutting portion 2013a in the second direction is fixed. Therefore, a spacing between the first fixed abutting portion 2013a and the second fixed abutting portion 2013b in the second direction is the minimum or close to the minimum, that is, the width W1 of the opening 2012 in the second direction is the minimum or close to the minimum, at this time, the nozzle assembly 3 is clamped into a clamping hole of the locking assembly 2. When the rotary member 202 is rotated to the put-down state shown in FIG. 8 along the direction N, the distance between the first axis 7 and the second fixed abutting portion 2013b is the minimum or close to the minimum. Because the distance between the first axis 7 and the first fixed abutting portion 2013a in the second direction is fixed, a spacing between the first fixed abutting portion 2013a and the second fixed abutting portion 2013b in the second direction is the maximum or close to the maximum, that is, the width W1 of the opening 2012 in the second direction is the maximum or close to the maximum. In this case, the locking assembly 2 releases the nozzle assembly 3, and the user can take off the nozzle assembly 3 from a printhead structure. It may be understood that in other embodiments, the rotatable abutting portion 2021 may be of other structures, as long as the first fixed abutting portion 2013a can be pressed or released by rotating the rotatable abutting portion 2021, which will not be described in detail here.

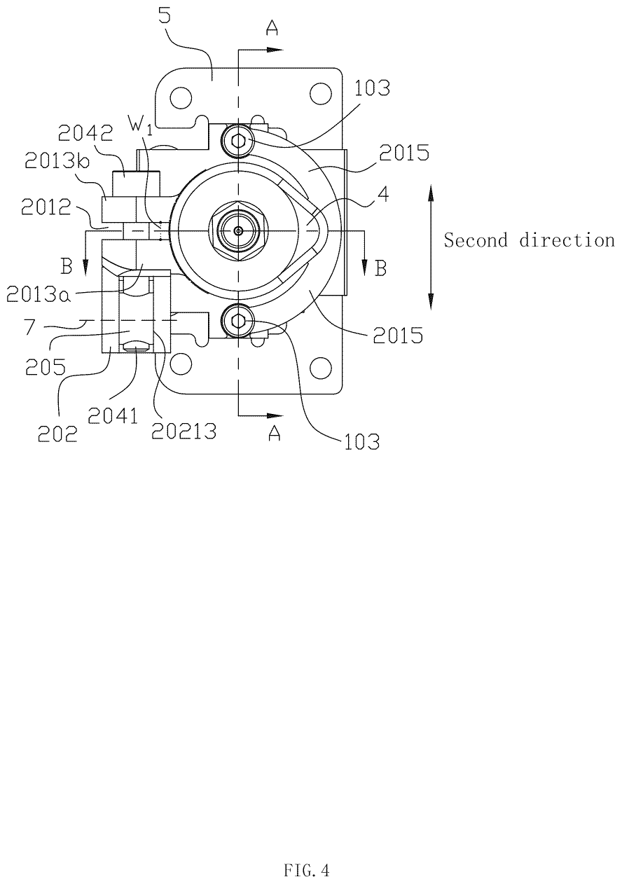

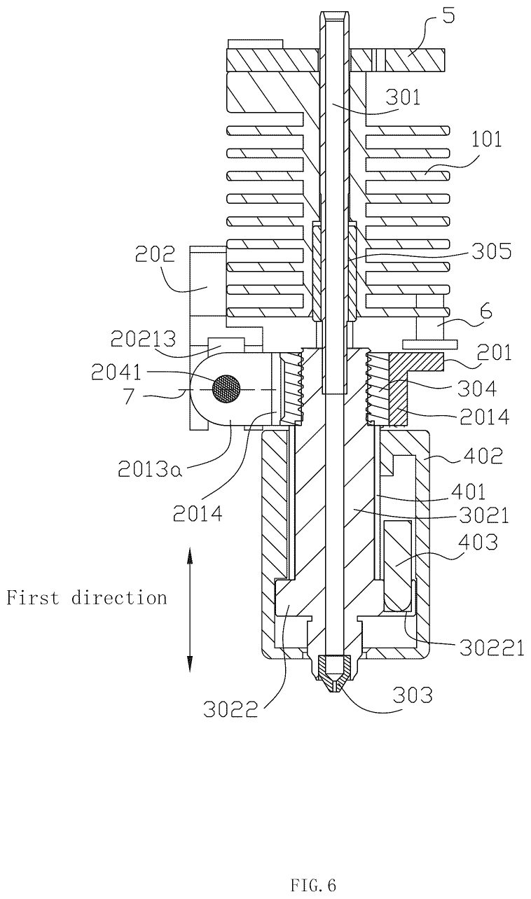

In this embodiment, the first axis 7 is perpendicular to the second direction, which is convenient for rotating the rotary member 202, and can prevent the rotary member 202 from interfering with other environmental elements when the rotary member 202 is rotated, making the spatial layout more reasonable and the structure simpler. As an example, with reference to FIG. 4 and FIG. 6, the first axis 7 may be perpendicular to the first direction and the second direction. Alternatively, the first axis 7 may also be parallel to the first direction.

It should be noted that in other embodiments, the first axis 7 may be perpendicular to the second direction in other directions, or the first axis 7 may be not perpendicular to the second direction, which may be set according to actual situations and thus will not be described in detail here.

As an embodiment, the locking assembly 2 may further include a gasket 203, the gasket 203 is arranged between the rotary member 202 and the clamping ring 201, and the gasket 203 and the clamping ring 201 are fixed, and one side, facing the rotary member 202, of the gasket 203 may be formed with the second mating surface 20132. The gasket 203 can effectively protect the clamping ring 201, prevent the clamping ring 201 from being damaged by frequent friction after long-term use, prolong the service life of the clamping ring 201, and reduce the use cost.

In some examples, the gasket 203 may be made of brass, and the gasket 203 made of brass has good metal lubricity, so that the rotary member 202 can bear frequent friction during rotation, the service life of the rotary member 202 is prolonged, and the use cost is reduced.

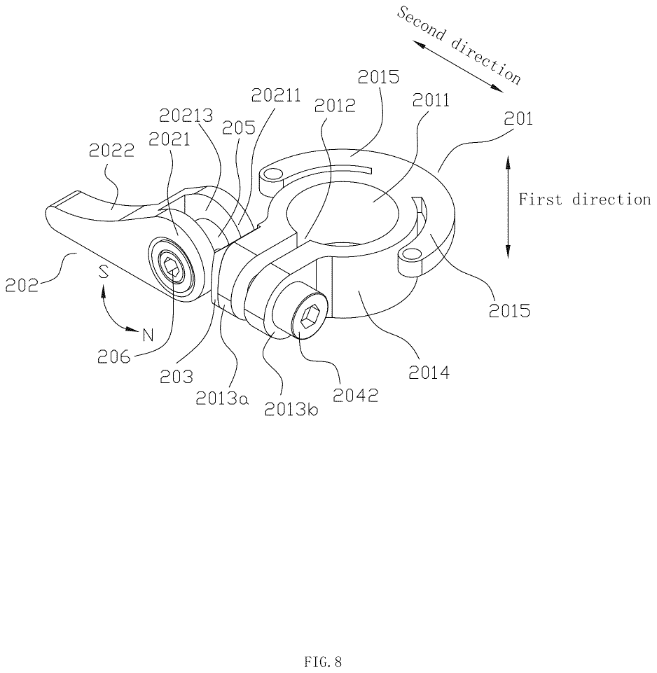

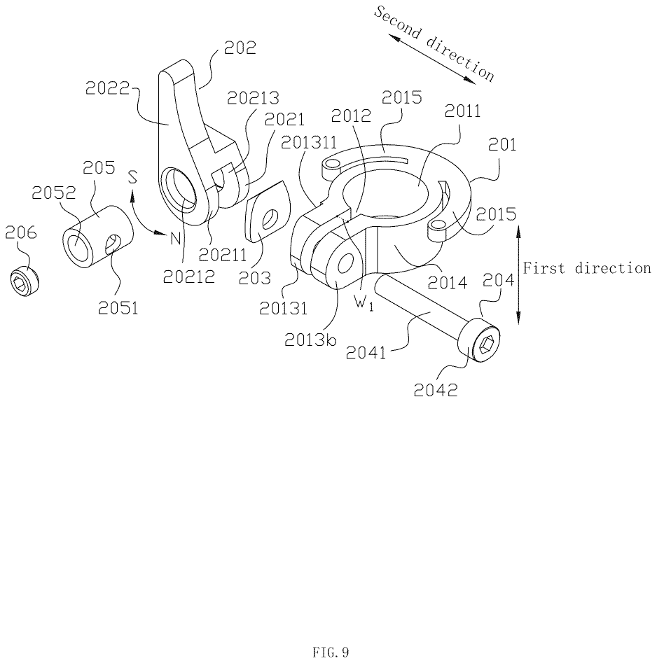

In some examples, with reference to FIG. 9, the gasket 203 may serve as a part of the first fixed butting portion 2013a. Specifically, the first fixed abutting portion 2013a may include a gasket 203 and bodies 20131, where the body 20131 is fixed to one side of the opening 2012, the gasket 203 is detachably connected to the body 20131, and the gasket 203 is arranged between the body 20131 and the body 20131. When damaged due to frequent friction, the gasket 203 can be replaced, and there is no need to replace the whole clamping ring 201, so that the use cost is reduced.

As an example, with reference to FIG. 3, one side surface, facing the rotatable abutting portion 2021, of the gasket 203, namely, the second mating surface 20132, may be construed as an arc-shaped surface. The arc-shaped second mating surface 20132 can effectively increase contact area between the gasket 203 and the rotatable abutting portion 2021, so that the force on the rotatable abutting portion 2021 and the gasket 203 is more uniform and dispersed, and the service life of the whole structure is further prolonged.

As an example, the gasket 203 may be partially embedded into the body 20131, the body 20131 is provided with an embedding recess 201311 in fit with the gasket 203, thereby improving the connection stability between the gasket 203 and the body 20131, preventing the gasket 203 from moving relative to the body, and improving the stability of an overall structure.

As an embodiment, the rotary member 202 further includes a handle portion 2022, which is convexly arranged on the rotatable abutting portion 2021 in a circumferential direction. When a user rotates the handle portion 2022, the rotatable abutting portion 2021 can be rotated, quick assembly and quick disassembly can be achieved by rotating once, making the user convenient. In other embodiments, the handle portion 2022 may also be fixed to other positions of the rotatable abutting portion 2021, which can be set according to actual situations and thus will not be described in detail here.

As an embodiment, with reference to FIG. 1 to FIG. 4, and FIG. 6 to FIG. 9, the locking assembly 2 further includes a first connector 204. The first connector 204 includes a first rod portion 2041 and a first flange portion 2042. The first rod portion 2041 extends along the second direction, the first flange portion 2042 is formed at one end of the first rod portion 2041 in the second direction, the other end of the first rod portion 2041 in the second direction is connected to the rotatable abutting portion 2021 after passing through the second fixed abutting portion 2013b and the first fixed abutting portion 2013a in turn. One end, away from the first fixed abutting portion 2013a, of the second fixed abutting portion 2013b in the second direction abuts against the first flange portion 2042. The rotatable abutting portion 2021 can rotate around the first axis 7 relative to the first rod portion 2041, and the rotatable abutting portion 2021 is rotatably connected to the clamping ring 201 through the first connector 204.

In this embodiment, the rotatable abutting portion 2021 is rotatably connected to one end of the first rod portion 2041 in the second direction, the other end of the first rod portion 2041 in the second direction is provided with the first flange portion 2042, one end, away from the first fixed abutting portion 2013a, of the second fixed abutting portion 2013b in the second direction abuts against the first flange portion 2042, thereby effectively limiting the distance between the first axis 7 and the second fixed abutting portion 2013b, and ensuring the stability of the overall structure.

As an embodiment, the rotatable abutting portion 2021 is provided with a first assembly hole 20212, and the first assembly hole 20212 takes the first axis 7 as the axis. The rotatable abutting portion 2021 is further provided with an avoidance groove 20213, the avoidance groove 20213 is arranged around the first axis 7, and the avoidance groove 20213 communicates with the first assembly hole 20212. The locking assembly 2 further includes a second connector 205, and the second connector 205 passes through the first assembly hole 20212. The first rod portion 2041 of the first connector 204 passes through the avoidance groove 20213 and is fixed to the second connector 205. When the rotary member 202 rotates around the first axis 7, under the action of the first connector 204, the second connector 205 remains unmoved, that is, the rotary member 202 and the second connector 205 are in rotatable connection, and the rotary member 202 may rotate around the first axis 7 relative to the second connector 205.

As an embodiment, the second connector 205 and the first connector 204 are detachably fixed, after a single part in the locking assembly 2 is worn, the first connector 204 can be detached to facilitate the replacement of the damaged part, which prolongs the service life of the nozzle module and reduces the use cost.

In some examples, the second connector 205 and the first connector 204 are in threaded connection. The second connector 205 is provided with a second assembly hole 2051, and the second assembly hole 2051 is a threaded hole. The second assembly hole 2051 is formed in a circumferential direction of the second connector 205 and extends along a radial direction of the second connector 205. The first connector 204 is threaded to the second assembly hole 2051, which is convenient for assembly and disassembly and more convenient for use.

As an example, the second connector 205 is further provided with a third assembly hole 2052, and the third assembly hole 2052 is a threaded hole. The third assembly hole 2052 takes the first axis 7 as the axis, and communicates with the second assembly hole 2051. The locking assembly 2 further includes a fastener 206 threaded into the third assembly hole 2052, and the fastener 206 can abut against the first connector 204 of the second assembly hole 2051. During assembly, the first connector 204 can be screwed into the second assembly hole 2051 of the second connector 205, and the first connector 204 can extend into or pass through the third assembly hole 2052, and then the fastener 206 is screwed into the third assembly hole 2052 until an end portion of the fastener 206 abuts against a periphery of the first connector 204. The fastener 206 can effectively fix the first connector 204 and the second connector 205 to prevent the first connector 204 and the second connector 205 from rotating relatively after long-term use, thereby improving the stability and assembly reliability of the nozzle module.

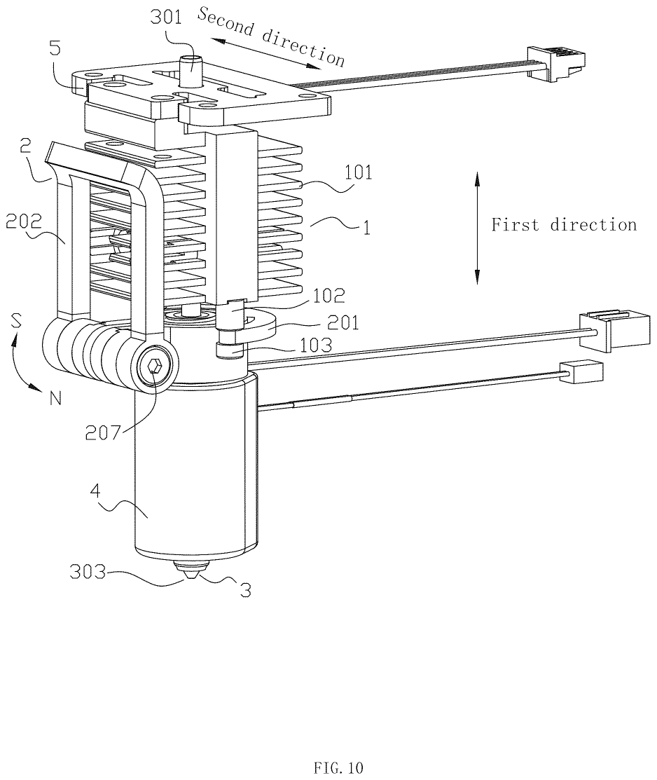

In some other embodiments, with reference to embodiments shown in FIG. 10 to FIG. 26, the rotary member 202 includes two rotatable abutting portions 2021, and the two rotatable abutting portions 2021 are spaced apart in the second direction. The two fixed abutting portions 2013 are located between the two rotatable abutting portions 2021, at least one of the two second rotatable abutting portions 2021 can press against or release the corresponding fixed abutting portion 2013 along the second direction, thereby making the two fixed abutting portions 2013 close to or far away from each other along the second direction.

As an example, with reference to FIG. 16, the two rotatable abutting portions 2021 can remain relatively fixed, that is, the two rotatable abutting portions 2021 rotate synchronously. The two rotatable abutting portions 2013 during rotation can press against or release corresponding fixed abutting portions 2013 simultaneously, thereby making the two fixed abutting portions 2013 close to or far away from each other along the second direction. Specifically, when the rotary member 202 is rotated along the direction S, the two rotatable abutting portions 2021 can simultaneously press against the corresponding fixed abutting portions 2013, so that the two fixed abutting portions 2013 can move towards each other in the second direction to reduce the width W1 of the opening 2012 and the aperture of the clamping hole 2011, enabling the clamping ring 201 to clamp the nozzle assembly 3. When the rotary member 202 is rotated along the direction N, the two rotatable abutting portions 2021 can simultaneously release the corresponding fixed abutting portions 2013, so that the two fixed abutting portions 2013 can move away from each other in the second direction to increase the width W1 of the opening 2012 and the aperture of the clamping hole 2011, enabling the clamping ring 201 to release the nozzle assembly 3. The operation is convenient, and quick assembly and quick disassembly can be effectively achieved.

As an embodiment, with reference to FIG. 17 to FIG. 26, the first mating surface 20211 may be a wedge-shaped surface, which is also a wedge-shaped surface. The first mating surface 20211 is arranged to face the corresponding second mating surface 20132 in the second direction, and arranged around the second axis 8, where the second axis 8 is parallel to the second direction, and the first mating surface 20211 also extends obliquely in the second direction. The second mating surface 20132 is arranged to face the corresponding first mating surface 20211 in the second direction, and arranged around the second axis 8, where the second mating surface 20132 also extends obliquely in the second direction.

In this embodiment, when the rotary member 202 is in a put-down state, point a of the first mating surface 20211 abuts against point b of the second mating surface 20132, please referring to FIG. 19. In this case, A width W2 of a combination of the rotatable abutting portion 2021 and the fixed abutting portion 2013 in the second direction is the minimum or close to the minimum, and the width W1 of the opening 2012 in the second direction is the maximum or close to the maximum. When the rotary member 202 is rotated along the direction S, the point a of the first mating surface 20211 is gradually far away from the point b, a height difference between the point a and the point b in the second direction becomes larger and larger, and the width W2 of the combination of the rotatable abutting portion 2021 and the fixed abutting portion 2013 in the second direction becomes larger and larger. Because the relative positions of the two rotatable abutting portions 2021 of the rotary member 202 are fixed, that is, the distance between the two rotatable abutting portions 2021 in the second direction is fixed, when the rotary member 202 is rotated along the direction S, the width W1 of the opening 2012 in the second direction becomes smaller and smaller. When the rotary member 202 is in the pull-up state, the height difference between the point a and the point b in the second direction reaches the maximum or is close to the maximum, the width W2 of the combination of the rotatable abutting portion 2021 and the fixed abutting portion 2013 in the second direction is the maximum or close to the maximum, please referring to FIG. 20. That is, the width W1 of the opening 2012 in the second direction is the minimum or close to the minimum. Therefore, when the rotary member 202 is rotated around the direction S, the first mating surface 20211 can press against the corresponding second mating surface 20132 to make the two fixed abutting portions 2013 move relatively in the second direction to reduce the width W1 of the opening 2012 in the second direction, thereby enabling the clamping ring 201 to clamp the nozzle assembly 3. When the rotary member 202 is rotated around the direction N, the first mating surface 20211 can release the corresponding second mating surface 20132 to make the two fixed abutting portions 2013 move away from each other in the second direction to increase the width W1 of the opening 2012 in the second direction, thereby enabling the clamping ring 201 to release the nozzle assembly 3.

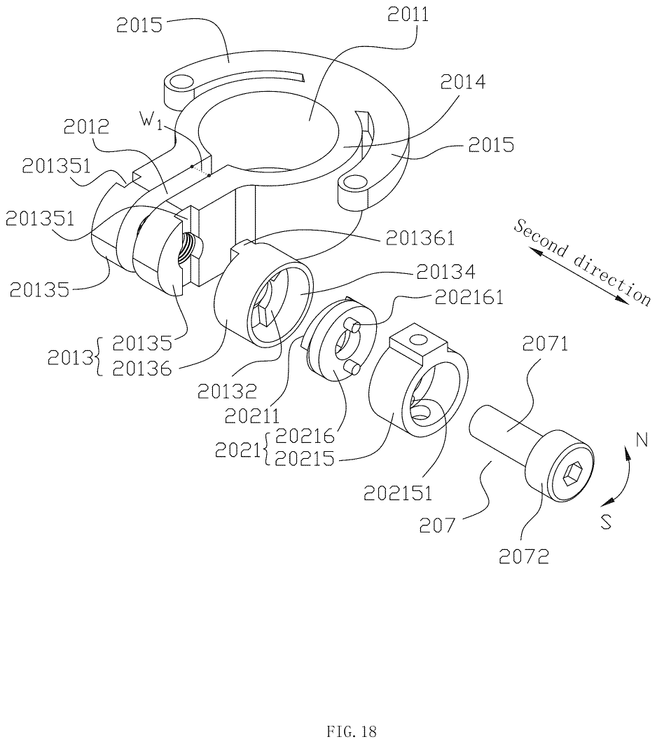

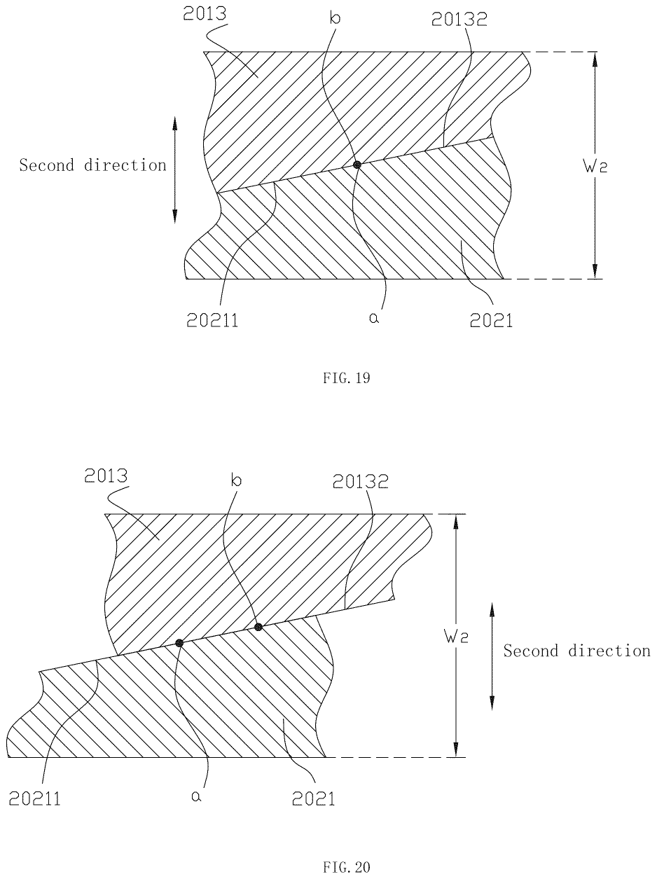

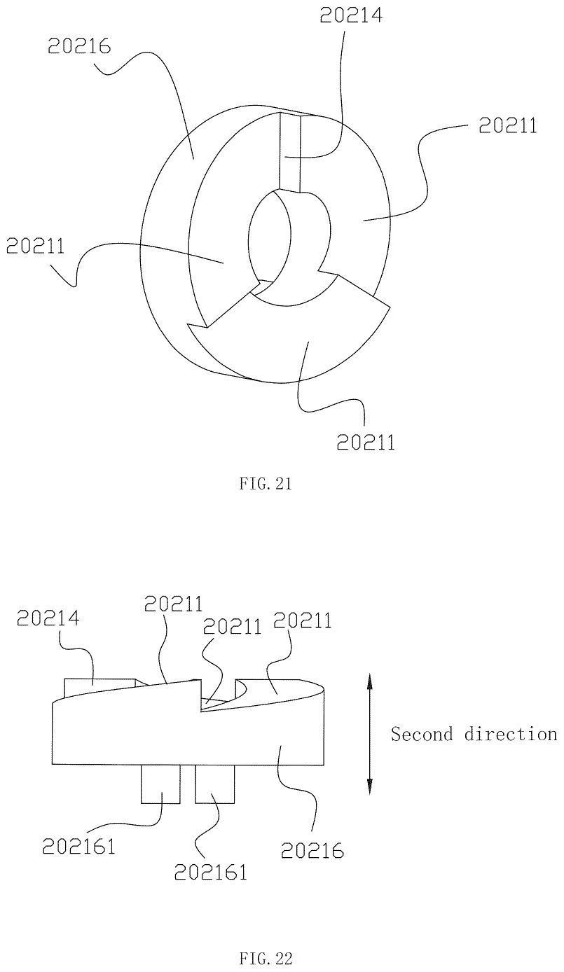

As an example, with reference to FIG. 17, FIG. 18, FIG. 21 to FIG. 26, the rotatable abutting portion 2021 may be provided with multiple first mating surfaces 20211, all the first mating surfaces 20211 are arranged around the second axis 8, and two adjacent first mating surfaces 20211 are connected by a first transition surface 20214. Correspondingly, the rotatable abutting portion 2013 may be provided with multiple second mating surfaces 20132, all the second mating surfaces 20132 are arranged around the second axis 8, and two adjacent second mating surfaces 20132 are connected by a second transition surface 20133. The number of the first mating surfaces 20211 is the same as that of the second mating surfaces 20132. The first mating surfaces 20211 are in one-to-one correspondence with the second mating surfaces 20132.

In this example, the rotatable abutting portion 2021 is provided with multiple first mating surfaces 20211, the fixed abutting portion 2013 is provided with a corresponding number of second mating surfaces 20132, and the first mating surface 20211 abuts against the corresponding second mating surface 20132. When rotating the rotary member 202, the force on the clamping ring 201 is more uniform and stable, and the nozzle assembly 3 can also be prevented from being pinched by excessively rotating the rotary member 202. In addition, arranging multiple first mating surfaces 20211 and second mating surfaces 20132 can effectively reduce a rotation angle of the rotary member 202 around the second axis 8, which further improves the assembly efficiency and disassembly efficiency, and is more convenient for operation.

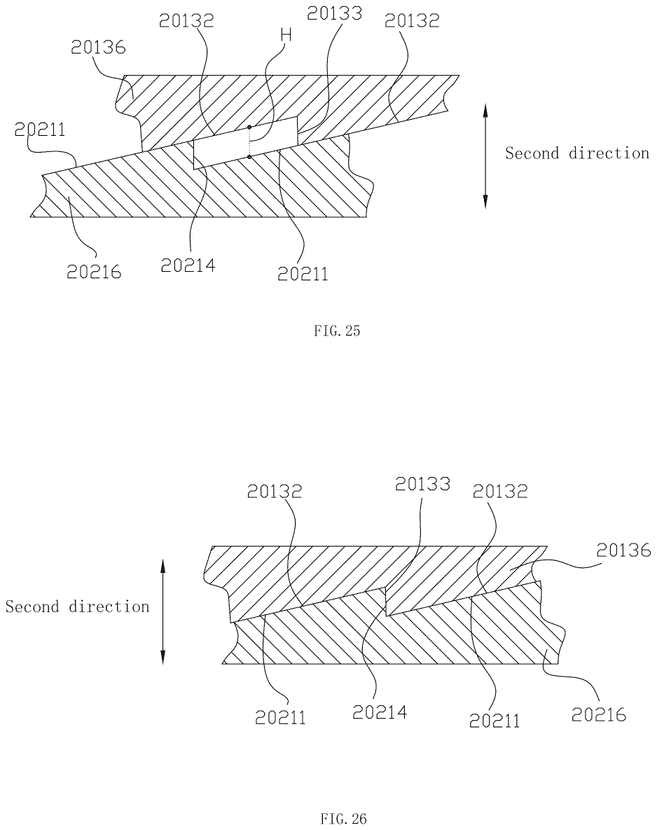

A working principle of this example is as follows: when the rotary member 202 is rotated to the pull-up state along the direction S, a cooperation state of the first mating surface 20211 and the second mating surface 20132 is as shown in FIG. 25, a height difference H between the first mating surface 20211 and the second mating surface 20132 in the second direction is the maximum or close to the maximum. Because the relative positions of the two rotatable abutting parts 2021 of the rotary member 202 are fixed, the width W1 of the opening 2012 in the second direction is the minimum or close to the minimum at this time, and the nozzle assembly 3 is clamped in the clamping hole of the locking assembly 2. When the rotary member 202 is rotated to the put-down state shown along the direction N, the cooperation state of the first mating surface 20211 and the second mating surface 20132 is as shown in FIG. 26, the height difference H between the first mating surface 20211 and the second mating surface 20132 in the second direction is the minimum or close to the minimum, for example, the height difference H may be zero. At this time, the width W1 of the opening 2012 in the second direction is the maximum or close to the maximum, the nozzle assembly 3 is released by the locking assembly 2, and the user can take off the nozzle assembly 3 from a printhead structure.

In some examples, with reference to FIG. 21 to FIG. 24, the rotatable abutting portion 2021 may be provided with three mating surfaces 20211, correspondingly, the fixed abutting portion 2013 may be provided with three second mating surfaces 20132, so that the structure is simple, and the production is convenient. The force on the clamping ring 201 is more uniform and stable, and the rotation angle of the rotary member 202 is effectively reduced.

It should be noted that in other embodiments, the rotatable abutting portion 2021 may further include one or other number of first mating surfaces 20211, and the fixed abutting portion 2013 may further include one or other number of second mating surfaces 20132, which can be set according to actual situations and thus will not be described in detail here.

In some examples, with reference to FIG. 22, FIG. 25 and FIG. 26, the first transition surface 20214 may be a plane parallel to the second axis 8. The second transition surface 20133 may be a plane parallel to the second direction. The rotary member 202 is rotated along the direction N until the first transition surface 20214 abuts against the corresponding second transition surface 20133, the rotary member 202 can no longer rotate along the direction N, which can effectively prompt the user that the nozzle assembly 3 has been released, and the nozzle assembly 3 can be taken out from the locking assembly 2 and the heat dissipation assembly 1. The use is more convenient, and sense of use is improved.

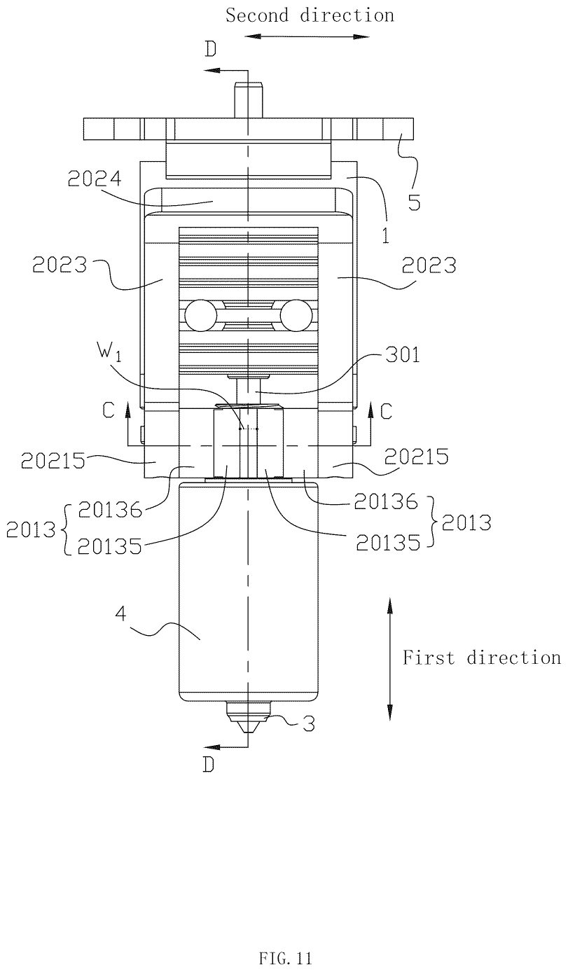

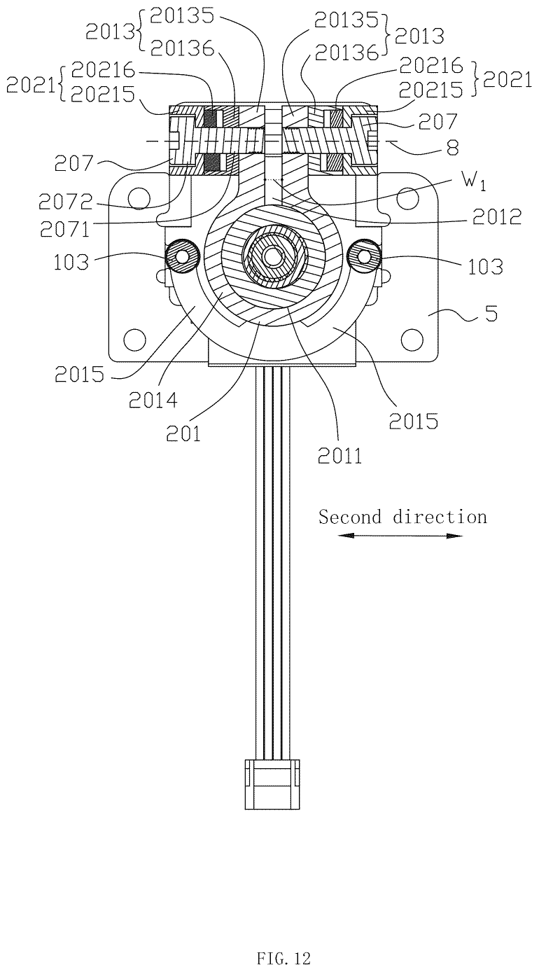

As an embodiment, with reference to FIG. 12, FIG. 17, FIG. 18 and FIG. 24, the fixed abutting portion 2013 has an accommodation hole 20134, which takes the second axis 8 as the axis, an orifice surface of the accommodation hole 20134 is arranged to face to the corresponding rotating abutting portion 2021, and the second mating surface 20132 is formed on a bottom surface of the accommodation hole 20134. The rotatable abutting portion 2021 may be rotatably connected into the accommodation hole 20134, when the rotary member 202 rotates relative to the locking assembly 2, the rotatable abutting portion 2021 rotates in the accommodation hole 20134.

In this embodiment, the rotatable abutting portion 2021 is accommodated into the fixed abutting portion 2013, so that the rotatable abutting portion 2021 and the fixed abutting portion 2013 can cooperate more stable and effective.

As an embodiment, with reference to FIG. 11, FIG. 16 and FIG. 17, the rotary member 202 further includes two first connecting arms 2023 and one second connecting arm 2024. The two first connecting arms 2023 are spaced apart and symmetrically arranged in the second direction, one end of the second connecting arm 2024 is connected to one end of one of the first connecting arms 2023, the other end of the second connecting arm 2024 is connected to one end of the other first connecting arm 2023, and the other ends of the two first connecting arms 2023 are respectively fixed with rotatable abutting portions 2021.

In this embodiment, the two first connecting arms 2023 are connected into a whole through the second connecting arm 2024, so that the relative positions of the two rotatable abutting portions 2021 can be effectively fixed. During use, the second connecting arm 2024 can be used as a handle, and the two rotatable abutting portions 2021 can be rotated synchronously by rotating the second connecting arm 2024, so that the two rotatable abutting portions 2021 can press against or release corresponding fixed abutting portions 2013 simultaneously to clamp or release the nozzle assembly 3. The use is convenient, and quick assembly and quick disassembly can be achieved by rotating once, the operation is convenient, and assembly and disassembly efficiency is improved. In addition, the two rotatable abutting portions 2021 are connected into a whole through the first connecting arm 2023 and the second connecting arm 2024, which can solve the problem that the rotary member 202 deflects after long-term use, and achieve that the performance of the nozzle module is unchanged after long-term use.

As an embodiment, the locking assembly 2 further includes two third connectors 207 which are symmetrically arranged in the second direction. The third connector 207 includes a second rod portion 2071 and a second flange portion 2072, the second rod portion 2071 takes the second axis 8 as the axis, the second flange portion 2072 is formed at one end of the second rod portion 2071 in the second direction, the other end of the second rod portion 2071 in the second direction passes through the corresponding rotatable abutting portion 2021, and an end portion of the other end of the second rod portion 2071 in the second direction is fixed to the corresponding fixed abutting portion 2013. To prevent the rotatable abutting portion 2021 from disengaging from the third connector 207, one side, away from the fixed abutting portion 2013, of the rotatable abutting portion 2021 in the second direction abuts against the second flange portion 2072.

In this embodiment, the rotary member 202 is rotatably connected to the clamping ring 201 through the third connector 207, where the rotary member 202 can rotate relative to the third connector 207, and the third connector 207 is fixed to the clamping ring 201, which is not only simple in structure, but also convenient to assembly.

As an embodiment, the third connector 207 may be detachably fixed to the clamping ring 201, thereby facilitating to disassemble the locking assembly 2. The damaged part can be replaced separately.

As an example, the third connector 207 may be threaded to the clamping ring 201. Specifically, a periphery of one end of the second rod portion 2071 connected to the clamping ring 201 may be provided with an external thread, and the fixed abutting portion 2013 may be provided with a threaded hole in fit with the external thread, and the second rod portion 2071 is threaded to the threaded hole, which is convenient for assembly and disassembly and more convenient for use. It should be noted that the rotary member 202 and/or the third connector 207 may be connected to the clamping ring 201 in other ways, which can be set according to actual situations, and thus will not be described in detail.

As an embodiment, with reference to FIG. 17 and FIG. 18, the rotatable abutting portion 2021 may be of a split structure. Specifically, the rotatable abutting portion 2021 may include a first connecting portion 20215 and a first mating portion 20216, and the first connecting portion 20215 and the first mating portion 20216 are detachably fixed. Both the first mating portion 20216 and the first connecting portion 20215 rotatably pass through the third connector 207, where the first connecting portion 20215 is fixed to the corresponding first connecting arm 2023, the first mating portion 20216 rotates synchronously with the first connecting portion 20215, and a first mating surface 20211 and the first transition surface 20214 are formed in the first mating portion 20216. When the first mating surface 20211 and/or the first transition surface 20214 are/is worn after long-term use, the first mating portion 20216 can be replaced separately, the use cost is reduced, and the service life of the overall structure is prolonged.

As an example, one of the first connecting portion 20215 and the first mating portion 20216 is provided with a first limiting protrusion, and the other of the first connecting portion 20215 and the first mating portion 20216 is provided with a first limiting recess. The first limiting protrusion and the first limiting recess are an inserted cooperation, so that a torque can be effectively transmitted, the first mating portion 20216 can rotate synchronously with the first connecting portion 20215, and the reliability of the overall structure is improved.

In some examples, with reference to FIG. 17 and FIG. 18, at least two first limiting protrusions 202161 evenly distributed around the second axis 8 can be formed at the end, away from the fixed abutting portion 2013, of the first mating portion 20216 in the second direction. Correspondingly, the first connecting portion 20215 is provided with first limiting recesses 202151 corresponding to the first limiting protrusions 202161 one by one, and the first limiting protrusions 202161 are inserted into the corresponding first limiting recesses 202151. The first limiting protrusions 202161 and the first limiting recesses 202151 in inserted cooperation can make the first mating portion 20216 rotate synchronously with the first connecting portion 20215, the first connecting arm 2023 and the second connecting arm 2024, so that the first mating portion 20216 will not rotate around the second axis 8 relative to the first connecting portion 20215. In addition, the first mating portion 20216 and the first connecting portion 20215 abut between the fixed abutting portion 2013 and the second flange portion 2072 in the second direction, so that the first limiting protrusion 202161 and the first limiting recess 202151 can be effectively connected, and the first limiting protrusion 202161 is prevented from being separated from the first limiting recess 202151.

It should be noted that in other embodiments, the first connecting portion 20215 and the first mating portion 20216 may be detachably fixed in other ways. Alternatively, the rotatable abutting portion 2021 may also be of an integrated structure, which can be set according to actual situations, and thus will not be described in detail here.

As an embodiment, with reference to FIG. 17 and FIG. 18, the fixed abutting portion 2013 may be of a split structure. Specifically, the fixed abutting portion 2013 may include a second connecting portion 20135 and a second mating portion 20136, and the second connecting portion 20135 and the second mating portion 20136 are detachably fixed. Both the second connecting portion 20135 and the second matching portion 20136 pass through the third connector 207, and both the second connecting portion 20135 and the second matching portion 20136 remain relatively fixed with the third connecting portion 207. The second connecting portion 20135 is fixed to one side of the opening 2012, the second mating surface 20132, the second transition surface 20133 and an accommodation hole 20134 are formed in the second mating portion 20136. When the second mating surface 20132 and/or the second transition surface 20133 are/is worn after long-term use, the second mating portion 20136 can be replaced separately, the use cost is reduced, and the service life of the overall structure is prolonged.

As an example, one of the second connecting portion 20215 and the second mating portion 20136 is provided with a second limiting protrusion, and the other of the second connecting portion 20215 and the second mating portion 20136 is provided with a second limiting recess. The second limiting protrusion and the second limiting recess are an inserted cooperation, so that the second mating portion 20136 can be effectively fixed, the second mating portion 20136 can be prevented from rotating with the first connecting portion 20216, and the reliability of the overall structure is improved.

In some examples, with reference to FIG. 17 and FIG. 18, a second limiting protrusion 201361 extending perpendicular to the second axis 8 is formed at one end, away from a movable abutting portion, of the second mating portion 20136 in the second direction, and correspondingly, the second connecting portion 20135 is provided with a second limiting recess 201351 in inserted cooperation with the second limiting protrusion 201361, and the second limiting protrusion 201361 and the second limiting recess 201351 in inserted cooperation can make the second mating portion 20136 and the second connecting portion 20135 kept fixed, so that the second mating portion 20136 does not rotate around the second axis 8 relative to the second connecting portion 20135. In addition, the second connecting portion 20135 is provided with a threaded hole in threaded connection with the second rod portion 2071, the second mating portion 20136 is abutted against between the rotatable abutting portion 2021 and the second connecting portion 20135, so that the second limiting protrusion 201361 and the second limiting recess 201351 can be effectively connected to prevent the second limiting protrusion 201361 from being separated from the second limiting recess 201351.

It should be noted that in other embodiments, the second connecting portion 20135 and the second mating portion 20136 may be detachably fixed in other ways. Alternatively, the fixed abutting portion 2013 may also be of an integrated structure, which can be set according to actual situations, and thus will not be described in detail here.

It should be noted in other embodiments, the two rotatable abutting portions 2021 can rotate at the same time, but only one of the rotatable abutting portions 2021 presses against or releases the corresponding fixed abutting portion 2013, and the other rotatable abutting portion 2021 will not press against or release the corresponding fixed abutting portion 2013 when rotating, so that one of the fixed abutting portions 2013 is close to or far away from the other fixed abutting portion 2013 in the second direction.

For example, only one pair of corresponding rotatable abutting portion 2021 and fixed abutting portion 2013 can be respectively provided with a first mating surface 20211 and a second mating surface 20132 for cooperation, and the other pair of corresponding rotating abutting portion 2021 and fixed abutting portion 2013 is not provided with the first mating surface 20211 and the second mating surface 20132. Abutting surfaces of the other pair of corresponding rotating abutting portion 2021 and fixed abutting portion 2013 in the second direction are planes perpendicular to the second axis 8, that is, the first mating surface 20211 and the second mating surfaces 20132 each can be replaced with a plane perpendicular to the second axis 8.

As an example, with reference to FIG. 17 and FIG. 18, the rotatable abutting portion 2021 may be detachably fixed to the first connecting arm 2023. For example, the rotatable abutting portion and the first connecting arm are fixed by a threaded connector. According to actual needs, one pair of rotatable abutting portion 2021 and fixed abutting portion 2013 with the first mating surface 20211 and the second mating surface 20132 is replaced with the rotatable abutting portion 2021 and the fixed abutting portion 2013 with the planes perpendicular to the second axis 8, which makes the use more flexible and can adapt to nozzle assemblies 3 with more diameters.

Alternatively, in other embodiments, the two rotatable abutting portions 2021 can rotate separately, the rotatable abutting portion 2021 in rotation will press against or release the corresponding fixed abutting portion 2013, so that the corresponding fixed abutting portion 2013 can be close to or away from another fixed abutting portion 2013 in the second direction.

For example, the first flange portion 2042 in the embodiment shown in FIG. 1 to FIG. 9 can be removed, and two rotary members 202 in the embodiment shown in FIG. 1 to FIG. 9 are symmetrically connected to the two ends of the first connector 204 in the second direction, so that states of the two rotary members 202 can be kept synchronous, or one rotary member 202 may be in the pull-up state and the other rotary member 202 may be in the put-down state, thereby adapting to nozzle assemblies 3 with more diameters.

In some embodiments, with reference to FIG. 17 and FIG. 18, the clamping ring 201 further includes a ring portion 2014, the ring portion 2014 has a clamping hole 2011 and an opening 2012, that is, two fixed abutting portions 2013 are fixed to the ring portion 2014. When the fixed abutting portion 2013 is of a split structure, the second connecting portion 20135 is fixed to the ring portion 2014. The clamping ring 201 further includes two fixing portions 2015, and the two fixing portions 2015 are symmetrically arranged about the ring portion 2014. One end of each fixing portion 2015 is formed in the ring portion 2014, the other end of each fixing portion 2015 extends along a circumferential direction of the ring portion 2014, there is a gap between the fixing portion 2015 and the ring portion 2014, and an end portion of the other end of the fixing portion 2015 is fixed to the heat dissipation assembly 1.

In this embodiment, there is a gap between the fixing portion 2015 and the ring portion 2014, which can effectively reduce heat transfer of the nozzle assembly 3 from the locking assembly 2 to the heat dissipation assembly 1, and improve the heat insulation effect. Moreover, the fixing portion 2015 extends along a circumferential direction of the ring portion 2014, which can effectively optimize the force on the fixing portion 2015, prevent the fixing part 2015 from breaking, and improve the product quality of the nozzle module.

As an embodiment, the fixing portion 2015 can be detachably fixed to the heat dissipation assembly 1, so that the part can be conveniently replaced, and the assembly and the disassembly are more convenient.

As an example, the heat dissipation assembly 1 is used for heat dissipation of the nozzle assembly 3, so that consumables in a throat 301 will not be molten, and smooth feeding is achieved. The heat dissipation assembly 1 includes a heat dissipation member 101, two heat insulation members 102, and two fixing members 103. The two heat insulation members 102 are symmetrically arranged on two sides of the heat dissipation member 101 in the second direction, the fixing members 103 are in one-to-one correspondence with the heat insulation members 102, and each fixing member 103 is fixed to the heat dissipation member 101 after penetrating through the corresponding fixing portion 2015 and heat insulation member 102 in turn. The nozzle assembly 3 passes through the heat dissipation member 101.

In this example, there is a heat insulation member 102 between the fixing portion 2015 and the heat dissipation member 101, which can effectively reduce heat transfer of the nozzle assembly 3 from the locking assembly 2015 to the heat dissipation assembly 101, and improve the heat insulation effect.

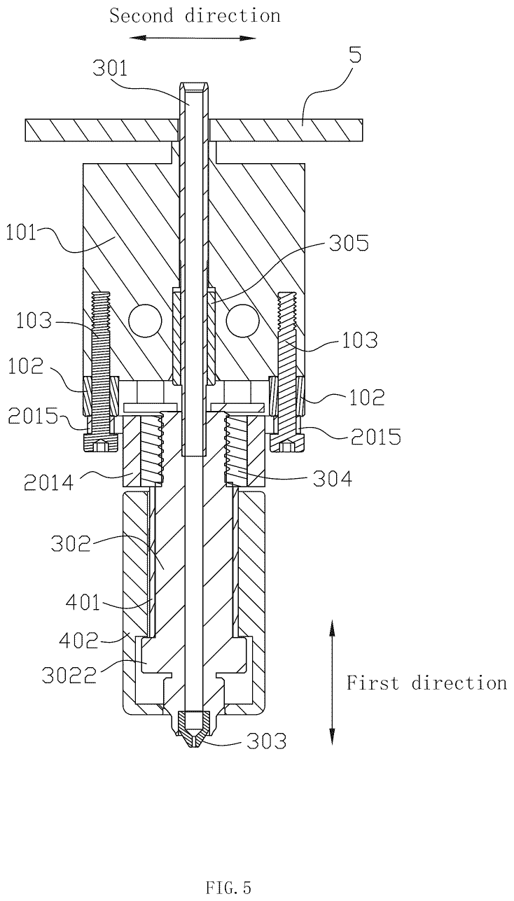

In some examples, with reference to FIG. 5 and FIG. 15, the fixing member 103 may be a threaded connector, for example, the fixing member 103 may be a screw. The fixing member 103 passes through the corresponding fixing portion 2015 and heat insulation member 102 in turn and is threaded to the heat dissipation member 101, so that the locking assembly 2 can be effectively fixed to the heat dissipation assembly 1, and the assemble and disassemble are convenient.

In some examples, the heat insulation member 102 may be made of nylon, thereby effectively blocking the heat transmission. It should be noted that in other embodiments, the heat insulation member 102 may be made of other materials, which may be set according to actual conditions and thus will not be described in detail here.

In some examples, the heat dissipation member 101 may include a cooling fin.

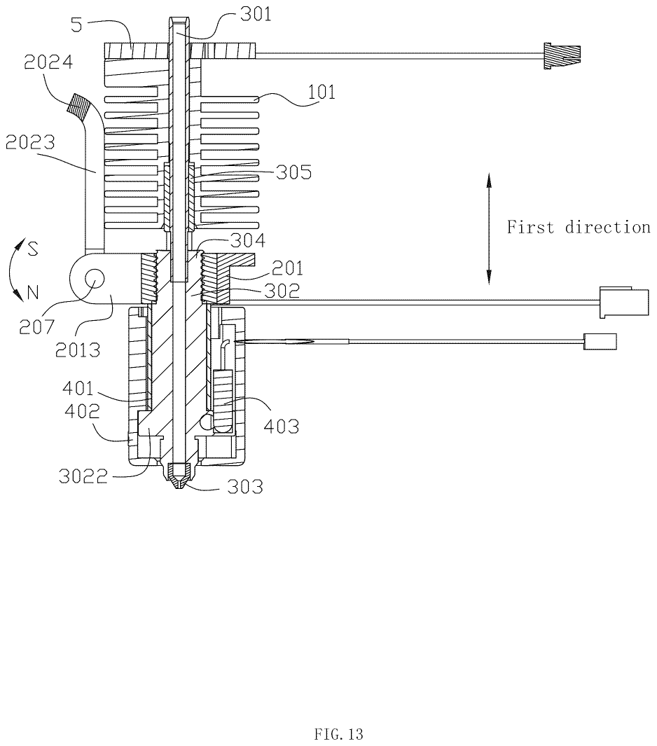

In some embodiments, with reference to FIG. 5, FIG. 6, FIG. 13, FIG. 15 and FIG. 18, the nozzle assembly 3 includes a throat 301, a heat-conducting pipe 302, a printhead 303 and a locking pipe 304, where the throat 301, the heat-conducting pipe 302 and the printhead 303 are sequentially fixed in a first direction, and the throat 301 passes through the heat dissipation assembly 1. The locking pipe 304 is fixed to the periphery of the heat-conducting pipe 302 and passes through the clamping hole 201. That is, the locking assembly 2 is in direct contact with the locking pipe 304. During assembly and disassembly, the locking assembly 2 directly clamps or loosen the locking pipe 304, thereby effectively protecting the heat-conducting pipe 302.

As an embodiment, the locking pipe 304 is detachably fixed to the heat-conducting pipe 302. When damaged due to long-term use, the locking pipe 304 can be replaced separately, which prolongs the service life of the overall structure and reduces the use cost.

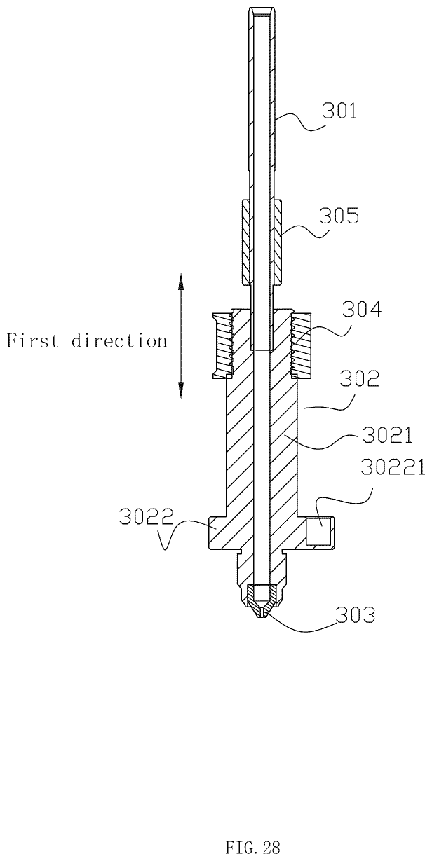

As an example, with reference to FIG. 28, the locking pipe 34 may be threaded to the heat-conducting pipe 302, which is not only simple in structure, but also convenient for assembly and disassembly.

In some examples, with reference to FIG. 28, The locking pipe 304 is provided with a threaded hole penetrating through the locking pipe 304 in the first direction, and correspondingly, a periphery of a joint between the heat-conducting pipe 302 and the locking pipe 304 is provided with an external thread in fit with the threaded hole.

It should be noted that in other embodiments, the locking pipe 304 and the heat-conducting pipe 302 may also be connected and fixed in other ways, which can be set according to the actual situation, and thus will not be described in detail here.

As an embodiment, the heat-conducting pipe 302 is in interference fit with the printhead 303, which can improve structure stability of the nozzle assembly 3.

In some examples, the heat-conducting pipe 302 may be made of copper, which has good heat-conducting effect. It should be noted that in other embodiments, the heat-conducting pipe 302 may be made of other materials, which can be set according to the actual situation, and thus will not be described in detail here.

As an embodiment, the nozzle assembly 3 further includes a heat dissipation pipe 305 detachably fixed to the periphery of the throat 301, and the heat dissipation pipe 305 is arranged between the heat dissipation member 101 and the throat 301, which can effectively protect the throat 301 and solve the problem that the throat 301 is damaged after long-term use. In addition, the heat dissipation pipe 305 is in close contact with the heat dissipation member 101 and the throat 301 separately, thereby ensuring that the heat of the throat member 301 can be quickly dissipated through the heat dissipation member 101.

As an example, the heat dissipation pipe 305 is sleeved on the periphery of the throat 301 in the first direction, and the heat dissipation pipe 305 is in interference fit with the throat 301, which not only makes the connection firmer, but also enables the heat of the throat member 301 to be transferred to the heat dissipation member 101 more quickly and effectively through the heat dissipation pipe 305.

In some examples, the heat dissipation pipe 305 may be made of copper, which has good heat dissipation effect. It should be noted that in other embodiments, the heat dissipation pipe 305 may be made of other materials, which can be set according to the actual situation, and thus will not be described in detail here.

In some embodiments, the nozzle module further includes a heating assembly 4, where the heating assembly 4 is sleeved outside the heat-conducting pipe 302. The heating assembly 4 is configured to heat consumables passing through the heat-conducting pipe 302, so that the printhead 303 can extrude consumables in a molten state.

As an embodiment, the heating assembly 4 is detachably fixed to the nozzle assembly 3. When the nozzle assembly 3 is quickly disassembled, the heating assembly 4 and the nozzle assembly 3 are integrally disassembled, that is, the heating assembly 4 is separated from the nozzle module together with the nozzle assembly 3.

As an example, with reference to FIG. 5, FIG. 6, FIG. 13 and FIG. 15, the heat-conducting pipe 302 may include a pipe portion 3021 and a third flange portion 3022, where the third flange portion 3022 protrudes from the pipe portion 3021 in a circumferential direction, and is arranged at one end, close to the printhead 303, of the pipe portion 3021. The locking pipe 304 is threaded to one end, away from the third flange portion 3022, of the pipe portion 3021, thereby fixing the heating assembly 4 between the third flange portion 3022 and the locking pipe 304.

In some embodiments, the heat dissipation assembly 4 includes a heating member 401. The heating member 401 is configured as a cylindrical structure sleeved outside the heat-conducting pipe 302, and the heating member 401 is configured to heat the heat-conducting pipe 302, thereby effectively heating the consumables to the molten state.

As an example, the heating member 401 may be an annular ceramic ring, and the annular ceramic ring is used to heat the heat-conducting pipe 302, which can make the heat transfer efficiency more efficient and the heat-conducting pipe 302 heated more uniform on the basis of quick disassembly, thereby solving the problem of uneven heating of the nozzle assembly 3.

As an embodiment, the heating assembly 4 may further include a protective case 402 which at least at least covers the heating element 401 to avoid heat leakage. The heating effect is ensured, and the heating is safer.

As an embodiment, to control the heating effect better, the heating assembly 4 may further include a temperature sensor 403.

As an example, with reference to FIG. 6 and FIG. 13, the third flange portion 3022 may be provided with a mounting hole 30221, the temperature sensor 403 can be partially inserted into the mounting hole 30211, which is not only convenient for mounting, but also makes the spatial layout more reasonable, and is more conducive to miniaturization of the nozzle module.

A three-dimensional printer provided by the embodiment of the present disclosure includes the nozzle module provided by any foregoing embodiment.

According to an embodiment of the present disclosure, the width W1 of the opening 2012 can be changed by rotating the rotary member 202, thereby changing the aperture of the clamping hole 2011 and making the clamping ring 202 clamp or release the nozzle assembly 3 passing through the clamping hole 201. Either quick assembly or quick disassembly can be achieved by rotating once, the assembly and disassembly processes are simple, no other tools are required, and the assembly efficiency and the disassembly efficiency are improved. In addition, the locking assembly 2 can firmly fix the nozzle assembly 3 and the heat dissipation assembly 1, a problem that the nozzle assembly 3 rotates and/or moves up and down during the movement is solved, and the nozzle assembly 3 is reliably fixed.

In some embodiments, the three-dimensional printer further includes a base (not shown), the heat dissipation member 101 of the heating dissipation assembly 1 is connected to the base through a pressure collector 5, and the pressure collector 5 may collect a pressure signal provided by the heat dissipation member 101.

As an example, the pressure collector 5 may be a strain gage. The heat dissipation member 101 and the pressure collector 5 are fixedly connected by a threaded connector such as a screw, and the pressure collector 5 is fixed to the base by a threaded connector such as a screw.

In some embodiments, the three-dimensional printer further includes a stopper 6. The heat dissipation assembly 1 is further connected to the base by the stopper 6, the stopper 6 and the pressure collector 5 are respectively arranged at two ends of the heat dissipation assembly 1 in the first direction, thereby effectively preventing the nozzle module from jittering during high-speed motion.

As an alternative embodiment, the stopper 6 may be threaded to the base, and the stopper 6 passes through the heat dissipation member 101 along the first direction, which is not only convenient for mounting, but also can effectively limit the heat dissipation assembly 1, making the assembly of the heat dissipation assembly 1 firmer and more stable.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments only describe several embodiments of the present disclosure, and their description is specific and detailed, but cannot be understood as a limitation to the patent scope of the present disclosure. It should be noted that a person of ordinary skill in the art may further make several variations and improvements without departing from the concept of the present disclosure, and these variations and improvements all fall within the scope of protection of the present disclosure. Therefore, the scope of protection of the patent of the present disclosure shall be subject to the appended claims.

1. A nozzle module, comprising:
a heat dissipation assembly;
a locking assembly, comprising a clamping ring fixed to the heat dissipation assembly and a rotary member connected to the clamping ring, wherein the clamping ring is provided with a clamping hole and an opening which penetrate through the clamping ring in a first direction, and the opening communicates with the clamping hole; and
a nozzle assembly, passing through the clamping hole and the heat dissipation assembly in turn along the first direction, wherein
the rotary member is able to rotate relative to the clamping ring, a width of the opening is selectively reduced or increased when the rotary member rotates relative to the clamping ring, thereby enabling the clamping ring to clamp or release the nozzle assembly.

2. The nozzle module according to claim 1, wherein the clamping ring is elastic, when the width of the opening is increased due to the rotation of the rotary member relative to the clamping ring, the nozzle assembly is able to be disconnected from the clamping ring under the action of own gravity.

3. The nozzle module according to claim 1, wherein the clamping ring is provided with two fixing abutting portions which are respectively formed on two sides of the opening in a second direction perpendicular to the first direction, wherein the second direction is a width direction of the opening;
the rotary member comprises a rotatable abutting portion corresponding to the fixed abutting portion, the rotatable abutting portion is provided with a first mating surface, the fixed abutting portion is provided with a second mating face abutting against the corresponding first mating surface in the second direction; and
the rotatable abutting portion is able to rotate relative to the fixed abutting portion to make the first mating surface press against or release the corresponding second mating surface along the second direction, thereby enabling the clamping ring to clamp or release the nozzle assembly.

4. (canceled)

5. The nozzle module according to claim 3, wherein the two fixed abutting portions are a first fixed abutting portion and a second fixed abutting portion;
the rotary member comprises one rotatable abutting portion, the rotatable abutting portion is arranged at one side, away from the second fixed abutting portion, of the first fixed abutting portion, and an end surface of one side, away from the second fixed abutting portion, of the first fixed abutting portion is construed as the second mating surface.

6. The nozzle module according to claim 5, wherein the first mating surface is a cam surface, a central axis of the cam surface is eccentrically arranged relative to a first axis perpendicular to the second direction, and relative positions of the first axis and the second fixed abutting portion are fixed; and
the rotary member is able to rotate around the first axis to enable the first mating surface press against or release the second mating surface along the second direction.

7. The nozzle module according to claim 6, wherein the locking assembly further comprises a first connector, the first connector comprises a first rod portion extending along the second direction and a first flange portion formed at one end of the first rod portion, and the other end of the first rod portion passes through the second fixed abutting portion and the first fixed abutting portion in turn and is connected to the rotatable abutting portion;
one end, away from the first fixed abutting portion, of the second fixed abutting portion in the second direction abuts against the first flange portion, and the rotatable abutting portion is able to rotate around the first axis relative to the first rod portion.

8. The nozzle module according to claim 7, wherein the rotatable abutting portion is provided with a first assembly hole with the first axis as an axis, the rotatable butting portion is further provided with an avoidance groove arranged around the first axis and communicating with first assembly hole;
the locking assembly further comprises a second connector, and the second connector passes through the first assembly hole; and
the first connector passes through the avoidance groove and is fixed to the second connector.

9. The nozzle module according to claim 8, wherein a circumferential direction of the second connector is provided with a second assembly hole extending along a radial direction of the second connector, the first connector is threaded to the second assembly hole, the second connector is further provided with a third assembly hole with the first axis as an axis, and the third assembly hole communicates with the second assembly hole;
the locking assembly further includes a fastener threaded to the third assembly hole, and the fastener is configured to abut against the first connector of the second assembly hole.

10. The nozzle module according to claim 3, wherein the rotary member comprises two rotatable abutting portions spaced apart in the second direction, the two fixed abutting portions are located between the two rotatable abutting portions, at least one of the second rotatable abutting portions is able to press against or release the corresponding fixed abutting portion along the second direction, thereby making the two fixed abutting portions close to or far away from each other.

11. The nozzle module according to claim 10, wherein the first mating surface and the second mating surface are both wedge-shaped surfaces arranged around a second axis parallel to the second direction and extending obliquely in the second direction;
the rotary member is able to rotate around the second axis to enable the first mating surface to press against or release the second mating surface along the second direction.

12. The nozzle module according to claim 11, wherein the rotatable abutting portion is provided with a plurality of first mating surfaces arranged around the second axis, and two adjacent first mating surfaces are connected by a first transition surface; and
the fixed abutting portion is provided with a plurality of second mating surfaces arranged around the second axis, and two adjacent second mating surfaces are connected by a second transition surface.

13. The nozzle module according to claim 11, wherein the fixed abutting portion is provided with an accommodation hole which is arranged to face the rotatable abutting portion and takes the second axis as an axis, the second mating surface is formed in a bottom surface of the accommodation hole, and the rotatable abutting portion is rotatably connected into the accommodation hole.

14. The nozzle module according to claim 3, wherein the rotary member further comprises two first connecting arms which are spaced apart and symmetrically arranged in the second direction, and a second connecting arm connected to one end of each of the two connecting arms, and the other ends of the two first connecting arms are fixed with the rotatable abutting portions, respectively.

15. The nozzle module according to claim 14, wherein the locking assembly further comprises two second connectors symmetrically arranged in the second direction;
the third connector comprises a second rod portion with the second axis as an axis, and a second flange portion formed at one end of the second rod portion, the other end of the second rod portion passes through the corresponding rotatable abutting portion and is fixed to the corresponding fixed abutting portion; and
one end, away from the fixed abutting portion, of the rotatable abutting portion in the second direction abuts against the second flange portion.

16. (canceled)

17. The nozzle module according to claim 3, wherein the fixed abutting portion is of a split structure, and comprises a second connecting portion and a second mating portion which are detachably fixed; the second connecting portion is fixed on one side of the opening, and the second mating surface is formed in the second mating portion; or
the fixed abutting portion is of an integrated structure.

18. The nozzle module according to claim 1, wherein the clamping ring further comprises a ring portion, and two fixing portions symmetrically arranged about the ring portion;
the ring portion is provided with the clamping hole and the opening;
one end of the fixing portion is formed in the ring portion, the other end of the fixing portion extends along a circumferential direction of the ring portion and is spaced from the ring portion by a gap, and an end portion of the other end of the fixing portion and the heat dissipation assembly are detachably fixed.

19. The nozzle module according to claim 18, wherein the heat dissipation assembly comprises a heat dissipation member, two heat insulation members, and two fixing members;
the two heat insulation members are symmetrically arranged on two sides of the heat dissipation member in a second direction perpendicular to the first direction, and the fixing member is fixed to the heat dissipation member after passing through the corresponding fixing portion and heat insulation member in turn; and
the nozzle assembly passes through the heat dissipation member.

20. The nozzle module according to claim 1, wherein the nozzle module comprises a throat, a heat-conducting pipe and a printhead which are connected in turn in the first direction, wherein the throat passes through the heat dissipation assembly, and the nozzle assembly further comprises a locking pipe fixed to a periphery of the heat-conducting pipe, and the locking pipe passes through the clamping hole.

21. (canceled)

22. The nozzle module according to claim 21, wherein the heat-conducting pipe comprises a pipe portion and a third flange portion protruding from the pipe portion in a circumferential direction, and the third flange portion is arranged at one end, close to the printhead, of the pipe portion;
the locking pipe is threaded to one end, away from the third flange portion, of the pipe portion; and
the heating assembly is arranged between the third flange portion and the locking pipe.

23. A three-dimensional printer, comprising the nozzle module which comprises:
a heat dissipation assembly;
a locking assembly, comprising a clamping ring fixed to the heat dissipation assembly and a rotary member connected to the clamping ring, wherein the clamping ring is provided with a clamping hole and an opening which penetrate through the clamping ring in a first direction, and the opening communicates with the clamping hole; and
a nozzle assembly, passing through the clamping hole and the heat dissipation assembly in turn along the first direction, wherein
the rotary member is able to rotate relative to the clamping ring, a width of the opening is selectively reduced or increased when the rotary member rotates relative to the clamping ring, thereby enabling the clamping ring to clamp or release the nozzle assembly.
